(19) United States
(12) Patent Application Publication
(10) Pub. No.: US 2025/0294146 A1
(43) Pub. Date: Sep. 18, 2025

(54) VIDEO ENCODING AND DECODING METHOD, DECODER, ENCODER AND COMPUTER-READABLE STORAGE MEDIUM

(71) Applicant: GUANGDONG OPPO MOBILE TELECOMMUNICATIONS CORP., LTD., Dongguan (CN)

(72) Inventor: Hang HUANG, Dongguan (CN)

(21) Appl. No.: 19/226,715

(22) Filed: Jun. 3, 2025

Related U.S. Application Data
(63) Continuation of application No. PCT/CN2022/137973, filed on Dec. 9, 2022.

(51) Int. Cl. H04N 19/117; H04N 19/176; H04N 19/196; H04N 19/513; H04N 19/82

(52) U.S. Cl. CPC H04N 19/117; H04N 19/176; H04N 19/196; H04N 19/521; H04N 19/82

(57) ABSTRACT

Disclosed is a video decoding method, and the method includes: parsing a bitstream, to determining a motion vector corresponding to a current block and a first filter type corresponding to the current block; determining a reference block corresponding to the current block based on the motion vector; determining a first filter corresponding to the first filter type, where the first filter includes at least: a sharp filter with at least 12 taps or a regular filter with at least 8 taps; and performing pixel value prediction and motion compensation based on the reference block using the first filter, to determine a predicted picture block corresponding to the current block.

### CROSS-REFERENCE TO RELATED APPLICATION

This application is a Continuation Application of International Application No. PCT/CN2022/137973 filed on Dec. 9, 2022, which is incorporated herein by reference in its entirety.

### TECHNICAL FIELD

Embodiments of the present disclosure relate to the video encoding and decoding technology, relate to but are not limited to, a video encoding and decoding method, a decoder, an encoder and a computer-readable storage medium.

### BACKGROUND

In the hybrid coding framework, the inter prediction technology is a primary means of removing temporal redundancy information from videos. The inter prediction technology is used to perform prediction and encoding on pixels of a current frame (picture) to be encoded through motion estimation and motion compensation technologies using a reconstructed frame (picture) of an encoded frame (picture) as a reference picture. The motion estimation refers to that an optimal matching reference block is searched for a current block to be encoded in a reference picture according to a specific matching criterion. The displacement from the reference block to the current block is the motion vector. The motion compensation generally refers to a process of performing pixel value prediction on the current block to be encoded based on pixel values of the reference block using an interpolation filter. Therefore, efficiency of video compression may be greatly improved by using an efficient inter encoding manner.

However, in the current video encoding and decoding, precision of the interpolation filter of the motion compensation process is low, thereby reducing accuracy of performing pixel value prediction using the interpolation filter and reducing performance of encoding and decoding.

### SUMMARY

The embodiments of the present disclosure provide a video encoding and decoding method, a decoder, an encoder and a computer-readable storage medium.

In a first aspect, the embodiments of the present disclosure provide a video decoding method, and the method includes:
parsing a bitstream, to determine a motion vector corresponding to a current block and a first filter type corresponding to the current block;
determining a reference block corresponding to the current block based on the motion vector;
determining a first filter corresponding to the first filter type, where the first filter includes at least: a sharp filter with at least 12 taps or a regular filter with at least 8 taps; and
performing pixel value prediction and motion compensation based on the reference block using the first filter, to determine a prediction picture block corresponding to the current block.

In a second aspect, the embodiments of the present disclosure further provide a video encoding method, and the method includes:
performing motion estimation on a current block based on a reference frame corresponding to a current frame, to determine a reference block corresponding to the current block;
determining a first filter type corresponding to the current block, and determining a first filter corresponding to the first filter type, where the first filter includes at least: a sharp filter with at least 12 taps or a regular filter with at least 8 taps; and
performing pixel value prediction and motion compensation based on the reference block using the first filter, to determine a prediction picture block corresponding to the current block.

In a third aspect, the embodiments of the present disclosure provide a decoder, and the decoder includes:
a parsing part, configured to parse a bitstream, to determine a motion vector corresponding to a current block and a first filter type corresponding to the current block;
a first motion estimation part, configured to determine a reference block corresponding to the current block based on the motion vector;
a first determination part, configured to determine a first filter corresponding to the first filter type, where the first filter includes at least: a sharp filter with at least 12 taps or a regular filter with at least 8 taps; and
a first motion compensation part, configured to perform pixel value prediction and motion compensation based on the reference block using the first filter, to determine a prediction picture block corresponding to the current block.

In a fourth aspect, the embodiments of the present disclosure provide an encoder, and the encoder includes:
a second motion estimation part, configured to perform motion estimation on a current block based on a reference frame corresponding to a current frame, to determine a reference block corresponding to the current block;
a second determination part, configured to determine a first filter type corresponding to the current block, and determine a first filter corresponding to the first filter type, where the first filter includes at least: a sharp filter with at least 12 taps or a regular filter with at least 8 taps; and
a second motion compensation part, configured to perform pixel value prediction and motion compensation based on the reference block using the first filter, to determine a prediction picture block corresponding to the current block.

In a fifth aspect, the embodiments of the present disclosure further provide a decoder, and the decoder includes:
a first memory, configured to store executable instructions; and
a first processor, configured to implement the video decoding method provided in the embodiments of the present disclosure when executing the executable instructions stored in the first memory.

In a sixth aspect, the embodiments of the present disclosure provide an encoder, and the encoder includes:
a second memory, configured to store executable instructions; and
a second processor, configured to implement the video encoding method provided in the embodiments of the present disclosure when executing the executable instructions stored in the second memory.

The embodiments of the present disclosure provide a bitstream, and the bitstream is generated by bit encoding based on information to be coded. The information to be encoded is determined based on a prediction picture block corresponding to a current block, the prediction picture block corresponding to the current block is obtained by performing pixel value prediction and motion compensation based on a reference block corresponding to the current block through a first filter corresponding to the current block, and the first filter includes at least: a sharp filter with at least 12 taps or a regular filter with at least 8 taps.

The embodiments of the present disclosure provide a computer-readable storage medium having a computer program stored thereon. When the computer program is executed by the first processor, the video decoding method provided by the embodiments of the present disclosure is implemented; or when the computer program is executed by the second processor, the video encoding method provided by the embodiments of the present disclosure is implemented.

### BRIEF DESCRIPTION OF THE DRAWINGS

FIG. 1 is a schematic block diagram of a composition of an encoder according to the embodiments of the present disclosure.

FIG. 2 is a schematic block diagram of a composition of a decoder according to the embodiments of the present disclosure.

FIG. 3 is a schematic diagram of a network architecture of a codec system according to the embodiments of the present disclosure.

FIG. 4 is an optional schematic flowchart of a decoding method according to the embodiments of the present disclosure.

FIG. 5 is a diagram illustrating a frequency response comparison between a 12-tap sharp filter and a current 8-tap sharp filter according to the embodiments of the present disclosure.

FIG. 6 is an optional schematic flowchart of a decoding method according to the embodiments of the present disclosure.

FIG. 7 is an optional schematic flowchart of a decoding method according to the embodiments of the present disclosure.

FIG. 8 is an optional schematic flowchart of a decoding method according to the embodiments of the present disclosure.

FIG. 9 is an optional schematic flowchart of a decoding method according to the embodiments of the present disclosure.

FIG. 10 is an optional schematic flowchart of a decoding method according to the embodiments of the present disclosure.

FIG. 11 is an optional schematic flowchart of a decoding method according to the embodiments of the present disclosure.

FIG. 12 is an optional schematic flowchart of a decoding method according to the embodiments of the present disclosure.

FIG. 13 is an optional schematic flowchart of a decoding method according to the embodiments of the present disclosure.

FIG. 14 is an optional schematic flowchart of an encoding method according to the embodiments of the present disclosure.

FIG. 15 is a first structural schematic diagram of a decoder according to the embodiments of the present disclosure.

FIG. 16 is a second structural schematic diagram of a decoder according to the embodiments of the present disclosure.

FIG. 17 is a first structural schematic diagram of an encoder according to the embodiments of the present disclosure.

FIG. 18 is a second structural schematic diagram of an encoder according to the embodiments of the present disclosure.

### DETAILED DESCRIPTION

The technical solutions in the embodiments of the present disclosure will be clearly and completely described below in conjunction with the drawings in the embodiments of the present disclosure. It is to be understood that specific embodiments described herein are merely for the purpose of explaining the related application, and are not intend to limit the present disclosure. It is also to be noted that, for the convenience of description, only parts related to the related disclosure are illustrated in the drawings.

It is to be noted that the “first”, “second”, “third” and so on mentioned throughout the specification are merely for the purpose of distinguishing different features, and do not have functions such as limiting priority, order of precedence or magnitude relationships.

The nouns and terms involved in the embodiments of the present disclosure are explained and the nouns and terms involved in the embodiments of the present disclosure are applicable to the following explanations:
Alliance for Open Media (AOM);
AOM Video Compression Reference Software (AOMedia Video Model, AVM);
Coding Tree Unit (CTU);
Motion Estimate (ME);
Motion Compensation (MC); and
Motion Vector (MV).

It may be understood that the digital video compression technology is mainly used to compress huge digital image video data for convenience of transmission, storage and so on. With proliferation in Internet videos and people's increasing demands for video definition, although existing digital video compression standards can save a lot of video data, there is still a need to pursue better digital video compression technologies to reduce bandwidth and traffic pressure of digital video transmission.

Similar to most of mainstream video encoding and decoding standards, the AVM reference software also performs conventional encoding and decoding by using a block-based manner, and the AVM reference software includes multiple modules, such as, block partition, intra prediction, inter prediction, transform, quantization, entropy coding, in-loop and post-processing filtering, and specific screen content coding. The present disclosure is mainly applied to encoding and decoding scenarios of AVM to improve the encoding and decoding performance by improving the inter prediction part.

In the hybrid coding framework, the inter prediction technology is a primary means of removing temporal redundancy information from videos. The inter prediction technology is used to perform prediction and encoding on pixels of a current frame (picture) to be encoded through motion estimation and motion compensation technologies using a reconstructed frame (picture) of an encoded frame (picture) as a reference picture. The motion estimation refers to that an optimal matching reference block is searched for a current block to be encoded in a reference picture according to a specific matching criterion. The displacement from the reference block to the current block is the motion vector. The motion compensation generally refers to a process of performing pixel value prediction on the current block to be encoded based on pixel values of the reference block using an interpolation filter. Therefore, video compression efficiency may be greatly improved by using an efficient inter encoding manner.

To improve the accuracy of inter prediction, flexible and diverse motion compensation techniques, including high-precision motion compensation, are usually adopted. In actual scenarios, since a distance at which an object moves is not necessarily an integer multiple of pixels, to more accurately represent the displacement of a moving object between pictures, it is necessary to upgrade the precision of motion estimation to a sub-pixel-level, and the motion compensation here is referred to as motion compensation in sub-pixel precision. In this way, the interpolation filter may be used at non-integer pixel positions to obtain predicted pixels. In the AV2 video standard, the motion vector may achieve a fractional-pixel precision of up to 1/16-pixel.

In an implementation of the AVM reference software, the decoder parses a bitstream to parse out a filter type used by the current block. Generally, the filter type is any one of: a regular filter type (REGULAR), a smooth filter type (SMOOTH) or a sharp filter type (SHARP). In the implementation of the AVM reference software, the default number of taps for each of the REGULAR and SMOOTH filters is 6, and the default number of taps for the SHARP filters is 8. In the actual encoding and decoding processes, each filter type has a corresponding set of filters with short-tap configurations (i.e., filters with a reduced number of taps). Generally, the number of taps of the short-tap REGULAR filter is 4, the number of taps of the short-tap SMOOTH filter is 4, and the short-tap SHARP filter is implemented by adopting the short-tap REGULAR filter. Generally, the filtering process is performed in both horizontal and vertical directions, and the decoder may determine whether the filter applied in the corresponding direction has the default number of taps or the short-tap configuration according to the width of the current block in the horizontal direction or the height of the current block in the vertical direction. Exemplarily, responsive to that the width of the current block is less than or equal to 4, the corresponding type of filter with 4 taps is selected in the horizontal direction, otherwise the filter with the default number of taps is adopted. Responsive to that the height of the current block is less than or equal to 4, the corresponding type of filter with 4 taps is selected in the vertical direction, otherwise the filter with the default number of taps is adopted.

At present, in AVM, there is still much room for improvement on the determination conditions for the number of taps and the existing interpolation filter. The lower order or insufficient coefficient precision of the interpolation filter itself, or unreasonable selection of the number of taps leads to a reduction in the filtering accuracy, thereby reducing the prediction accuracy and further reducing the performance of encoding and decoding.

The embodiments of the present disclosure provides a video encoding and decoding method, a decoder, an encoder and a computer-readable storage medium, which may improve the accuracy of encoding and decoding and further improve the performance of encoding and decoding. Various embodiments of the present disclosure will be described in detail below with reference to the accompanying drawings.

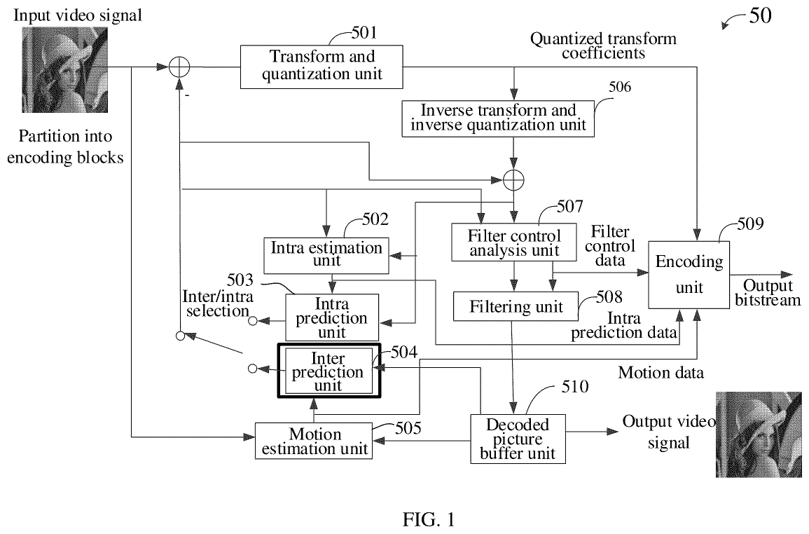

Referring to FIG. 1, a schematic block diagram of a composition of an encoder according to the embodiments of the present disclosure is illustrated. As illustrated in FIG. 1, the encoder (exemplarily, a “video encoder”) 50 may include a transform and quantization unit 501, an intra estimation unit 502, an intra prediction unit 503, an inter prediction unit 504, a motion estimation unit 505, an inverse transform and inverse quantization unit 506, a filter control analysis unit 507, a filtering unit 508, an encoding unit 509 and a decoded picture buffer unit 510, and so on. The filtering unit 508 may implement deblocking filtering and sample adaptive offset (SAO) filtering, and the encoding unit 509 may implement header information coding and context-based adaptive binary arithmetic coding (CABAC). For an input original video signal, one video encoding block may be obtained through coding tree unit (CTU) partitioning, and then, residual pixel information of the video encoding block obtained through intra prediction or inter prediction may be transformed using the transform and quantization unit 501, which includes that residual information in a pixel domain is transformed into residual information in a transform domain, and an obtained transform coefficient is quantized to further reduce the bit rate. The intra estimation unit 502 and the intra prediction unit 503 are configured to perform intra prediction on the video encoding block. Exemplarily, the intra estimation unit 502 and the intra prediction unit 503 are configured to determine an intra prediction mode to be used to encode the video encoding block. The inter prediction unit 504 and the motion estimation unit 505 are configured to perform inter prediction encoding on a received video encoding block with respect to one or more blocks in one or more reference frames/pictures to provide time prediction information. The motion estimation performed by the motion estimation unit 505 is a process of generating a motion vector, and the motion vector may estimate the motion of the video encoding block, and then, the inter prediction unit 504 performs motion compensation based on the motion vector determined by the motion estimation unit 505. Therefore, the inter prediction unit 504 may also be referred to as a motion compensation unit. After the intra prediction mode has been determined, the intra prediction unit 503 is further configured to provide selected intra prediction data to the encoding unit 509, and the motion estimation unit 505 also transmits computed and determined motion vector data to the encoding unit 509. In addition, the inverse transform and inverse quantization unit 506 is configured to reconstruct the video encoding block, reconstruct a residual block in the pixel domain and provide the reconstructed residual block to the filter control analyzing unit 507 and the filtering unit 508, to remove a blocking artifact, and then, add the reconstructed residual block to a prediction block in a frame/picture in the decoded picture buffer 110, to produce a reconstructed video encoding block. The encoding unit 509 is configured to encode various coding parameters and quantized transform coefficients, context content in a CABAC-based coding algorithm may be based on a neighboring coding block, and the coding unit 509 may be further configured to encode information indicating the determined intra prediction mode and output a bitstream of the video signal. The decoded picture buffer 510 is configured to store the reconstructed video coding block for prediction reference. As video picture encoding progresses, new reconstructed video coding blocks are generated continuously, these reconstructed video coding blocks may all be stored in the decoded picture buffer 510.

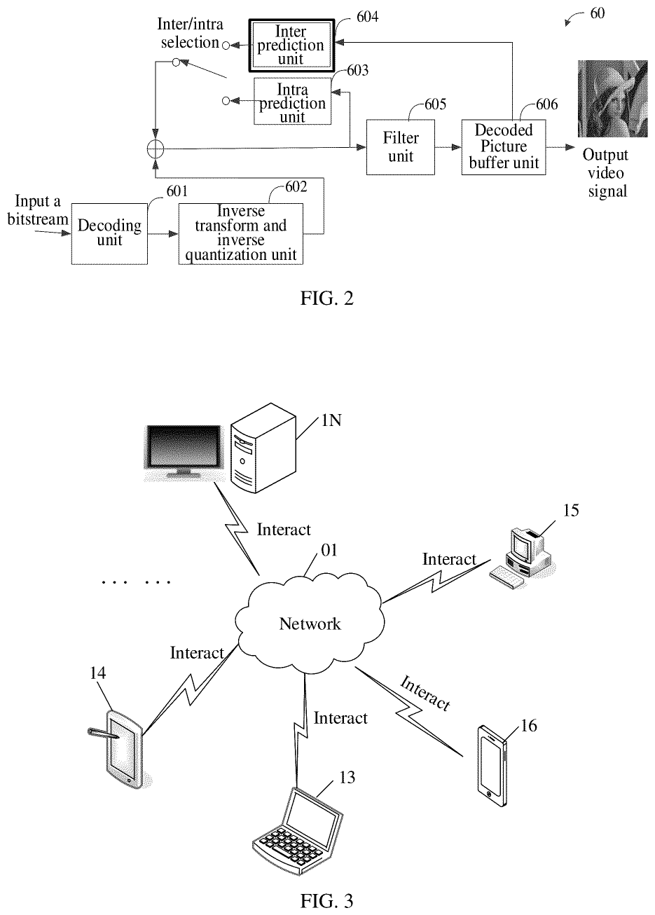

Referring to FIG. 2, a schematic block diagram of a composition of a decoder according to the embodiments of the present disclosure is illustrated. As illustrated in FIG. 2, the decoder (exemplarily, a “video decoder”) 60 includes a decoding unit 601, an inverse transform and inverse quantization unit 602, an intra prediction unit 603, an inter prediction unit 604, a filtering unit 605, a decoded picture buffer unit 606, and so on. The decoding unit 601 may implement header information decoding and CABAC decoding. The filtering unit 605 may implement deblocking filtering and SAO filtering. After the input video signal has gone through encoding processing illustrated in FIG. 1, a bitstream of the video signal is output. The bitstream is input to the decoder 60, and first go through the decoding unit 601 to obtain decoded transform coefficients. The transform coefficients are processed by the inverse transform and inverse quantization unit 602, to generate a residual block in the pixel domain. The intra prediction unit 603 may be configured to generate prediction data of the current video decoding block based on the determined intra prediction mode and data of a decoded block from the current frame or picture. The inter prediction unit 604 is configured to determine prediction information used for the video decoding block by analyzing the motion vector and other associated syntax elements, and generate a prediction block of the video decoding block being decoded using the prediction information. The residual block from the inverse transform and inverse quantization unit 602 and the corresponding prediction block generated by the intra prediction unit 603 or the inter prediction unit 604 is summed to form a decoded video block. The decoded video signal is provided to the filtering unit 605 to remove a blocking artifact, which may improve video quality. Then, the decoded video block is stored in the decoded picture buffer unit 606, the decoded picture buffer unit 606 stores reference pictures used for subsequent intra prediction or motion compensation, and also is configured to output the video signal, that is, a recovering original video signal is obtained.

Furthermore, the embodiments of the present disclosure further provide a network architecture of a codec system including an encoder and a decoder, and FIG. 3 is a schematic diagram of the network architecture of the codec system according to the embodiments of the present disclosure. As illustrated in FIG. 3, the network architecture includes one or more electronic devices 13 to 1N and a communication network 01, where the electronic devices 13 to 1N may perform video interaction through the communication network 01. During the implementation process, the electronic devices may be various types of devices having video encoding and decoding functions. For example, the electronic devices may include a smart phone, a tablet computer, a personal computer, a personal digital assistant, a navigator, a digital phone, a video phone, a television, a sensor device, a server, and so on, and the embodiments of the present disclosure do not impose specific limitations. Here, the decoder or encoder described in the embodiments of the present disclosure may be the electronic device mentioned above.

It should be noted that the methods in the embodiments of the present disclosure are mainly applied to the inter prediction unit 504 part as illustrated in FIG. 1 and the inter prediction unit 604 part as illustrated in FIG. 2. That is, the embodiments of the present disclosure may be applied to both the encoder and the decoder, or may even be applied to both the encoder and decoder at the same time; however, the embodiments of the present disclosure do not impose specific limitations.

It should also be noted that when the method is applied to the inter prediction unit 504 part, exemplarily, the “current block” refers to an encoding block on which inter prediction is currently to be performed; and when the method is applied to the inter prediction unit 604 part, exemplarily, the “current block” refers to a decoding block on which inter prediction is currently to be performed.

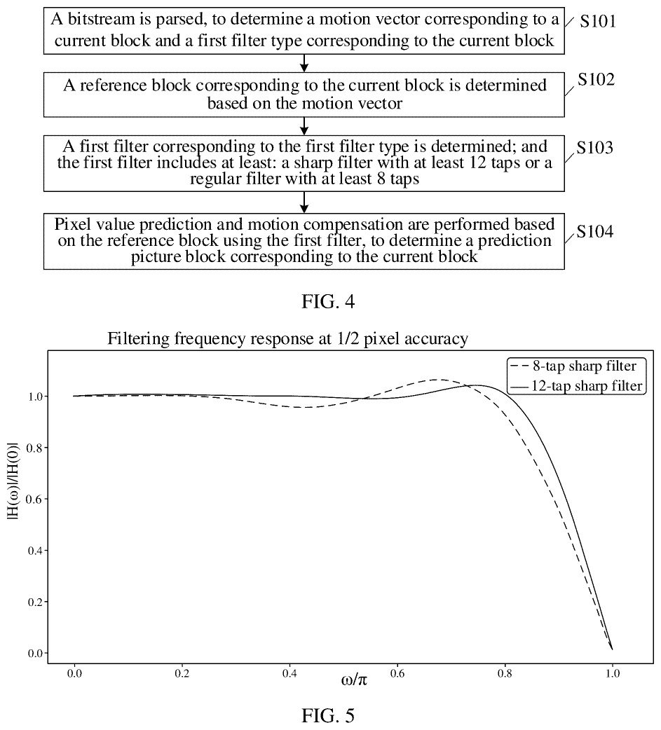

In an embodiment of the present disclosure, referring to FIG. 4, a schematic flowchart of a decoding method according to the embodiments of the present disclosure is illustrated. The method may include the following.
S101, a bitstream is parsed, to determine a motion vector corresponding to a current block and a first filter type corresponding to the current block.

In S101, a decoder receives the bitstream transmitted by an encoder, and obtains a current frame in the bitstream by parsing the bitstream, where the current frame includes multiple encoding blocks (encoding units). The decoder parses the current block in the current frame to obtain the motion vector (MV) corresponding to the current block and the first filter type corresponding to the current block. Here, the first filter type is a filter type designated by the encoder for the current block and used for the interpolation filtering process of motion compensation.

In some embodiments, the current block may be a current coding unit (CU), a current transform unit (TU), a current prediction unit (PU), a current coding block (CB), and the like; and the embodiments of the present disclosure do not impose specific limitations.
S102, a reference block corresponding to the current block is determined based on the motion vector.

In S102, the decoder may also obtain a reference frame index corresponding to the current block by parsing the current block, and then determine the reference frame corresponding to the current block. Here, the reference frame may be a forward or backward decoded frame corresponding to the current frame. Exemplarily, the reference frame index may be inter_pred_idc, and the reference frames may include a LAST (most recent past) frame, a GOLDEN (long-term past) frame, an ALTREF (temporally filtered future) frame, and the like. In this way, the decoder may determine a matching picture block from the reference frame according to the motion vector corresponding to the current block as the reference block corresponding to the current block. Here, the reference block may also be referred to as a “compensation block”.

Exemplarily, for the unidirectional prediction process of inter prediction, the decoder may determine the reference block corresponding to the current block from the List0 reference frame or List1 reference frame according to the motion vector. For the bidirectional prediction process of inter prediction, the decoder may determine the List0 reference block from the List0 reference frame, and determine the List1 reference block from the List1 reference frame.
S103, a first filter corresponding to the first filter type is determined; and the first filter includes at least: a sharp filter with at least 12 taps or a regular filter with at least 8 taps.

In S103, the first filter type corresponds to and includes filters with at least one tap count (i.e., filters with at least one tap-length configuration). The decoder may determine, from the filters with at least one tap count corresponding to the first filter type, a filter with a specific number of taps for performing interpolation filtering on the current block, and designated as the first filter.

In the embodiments of the present disclosure, the decoder is preset to support at least one filter type, and the at least one filter type includes the first filter type. Each filter type among the at least one filter type corresponds to and includes filters with at least one tap count. Exemplarily, the at least one filter type may include at least one of: a sharp filter type, a regular filter type or a smooth filter type. The sharp filter type includes at least: the sharp filter with at least 12 taps, and may further include sharp filters with other numbers of taps, e.g., a 4-tap sharp filter. The regular filter type includes at least: the regular filter with at least 8 taps, and may further include the regular filter with other numbers of taps, e.g., a 4-tap regular filter. The specific selection is made according to the actual situations and is not limited to the embodiments of the present disclosure.

In some embodiments, the decoder may determine a frame-level filter switching flag by parsing the current frame, e.g., parsing a frame header of the current frame. Here, the frame-level filter switching flag is used for representing whether a filter for performing filtering on each block in the current frame is switchable. Exemplarily, the frame-level filter switching flag may be is filter switchable, which is set by the encoder at the frame-level of the encoded frame. In a case where the frame-level filter switching flag parsed is set to a first preset flag value, the decoder determines a block-level filter type index corresponding to the current block; the first preset flag value represent that the current frame corresponds to at least two filter types; and according to the block level filter type index, the first filter type is determined in combination with the preset correspondence between the filter type index and the filter type.

In a case where the frame-level filter switching flag is set to a second preset flag value, the decoder continues to parse the frame-level filter type index corresponding to the current frame from the current frame; and the frame-level filter type index is taken as a block-level filter type index corresponding to each block in the current frame. Here, the second preset flag value represent that the current frame corresponds to one filter type.

Exemplarily, the first preset flag value may be 1, and the second preset flag value may be 0. When the frame-level filter switching flag parsed by the decoder is 1, it is indicated that there exists a situation of different filters being used in the current frame picture. When decoding each block (unit block information) subsequently, the interpolation filter number used by the current block is decoded continuously. Here, the interpolation filter number is equivalent to the block-level filter type index mentioned above. Exemplarily, three values of 0, 1 and 2 may be included, and the three values correspond to three filter types of REGULAR, SMOOTH and SHARP, respectively. When the parsed frame-level filter switching flag is 0, it is indicated that the same filter is used by the entire frame picture. The decoder further parses the filter number used by the current frame, that is, the frame-level filter type index mentioned above. Here, the correspondence between the frame-level filter type index and the filter type may be the same as the correspondence between the block-level filter index and the filter type.

In some embodiments, in a case where the frame-level filter switching flag is set to the first preset flag value, for the current block in the current frame, the decoder may determine, based on a size of the current block, a filter with a corresponding number of taps in the first filter type corresponding to the current block in at least one preset filtering direction, that is, the first filter. The size of the current block may include: a length of the current block in at least one preset filtering direction (such as a width in a horizontal direction or a height in a vertical direction); or include: area information of the current block, a diagonal length, and the like, where the specific selection is made according to actual situations and is not limited to the embodiments of the present disclosure. Further, in a case where the frame-level filter switching flag is set to the first preset flag value, when performing filtering processing of inter-prediction on the next block in the current frame, the decoder determines the first filter corresponding to a next block in the same manner. That is, according to the first filter type designated by the encoder and the size of each block in the current frame, the decoder may adaptively select the filter with the corresponding number of taps in the first filter type for each block in the current frame as the first filter corresponding to each block.

Compared with the configuration of motion compensation interpolation filter in the current standard, in the embodiments of the present disclosure, the first filter includes at least: a sharp filter with at least 12 taps or a regular filter with at least 8 taps. It can be seen that, in the embodiments of the present disclosure, the number of taps (order) for the sharp filter and the regular filter has been improved. Here, a larger number of taps or a higher order means that more pixels (pixel points) are used for reference when performing interpolation filtering of pixel values, which may bring more stopband attenuation, fewer ripples, narrower filtering, and so on, thereby improving prediction accuracy. Exemplarily, the first filter may include: a 12-tap sharp filter, or a 14-tap sharp filter, or a 16-tap sharp filter, or include: an 8-tap regular filter, and so on.

In some embodiments, the coefficients of the filter with the improved number of taps are also optimized in the embodiments of the present disclosure. Where the sharp filter with at least 12 taps may include: a respective first filtering coefficient corresponding to each of the at least 12 taps at each pixel position of at least one pixel position. Here, the pixel position includes a pixel position of an integer pixel and a pixel position of a non-integer pixel (i.e., a sub-pixel). The first filtering coefficient at each pixel position may be obtained by performing processing on a random signal through a first preset sampling function (e.g., a sinc function) and normalizing a first processing result obtained to a preset coefficient interval corresponding to a preset bit depth. In some embodiments, the preset bit depth may be 7 bits, and the random signal may be an independent variable waveform signal with a value range of [−∞, +∞]. By performing windowing processing on the independent variable waveform signal through the sinc function, the waveform signal between [−1, +1] (that is, the first processing result) may be obtained. The waveform signal between [−1, +1] is projected to the coefficient interval of [−128, 128] corresponding to 7 bits (that is, the first processing result is normalized), to obtain the first filtering coefficient(s). Exemplarily, taking the sub-pixel precision of 1/16-pixel as an example, the filtering coefficients of the 12-tap sharp filter may be as shown in Table 1.

TABLE 1

| | | | | | | | | | | | | |
|---|---|---|---|---|---|---|---|---|---|---|---|---|
| 1/16 | 0 | 1 | −2 | 3 | −7 | 127 | 9 | −4 | 2 | −1 | 0 | 0 |
| 2/16 | −1 | 2 | −4 | 7 | −14 | 125 | 17 | −7 | 4 | −2 | 1 | 0 |
| 3/16 | −1 | 2 | −4 | 8 | −18 | 121 | 27 | −11 | 6 | −3 | 2 | −1 |
| 4/16 | −1 | 3 | −6 | 11 | −22 | 115 | 38 | −15 | 8 | −4 | 2 | −1 |
| 5/16 | −1 | 3 | −6 | 12 | −24 | 108 | 49 | −19 | 10 | −6 | 3 | −1 |
| 6/16 | −1 | 4 | −7 | 13 | −26 | 100 | 59 | −21 | 11 | −6 | 3 | −1 |
| 7/16 | −1 | 3 | −7 | 13 | −26 | 91 | 70 | −23 | 12 | −6 | 3 | −1 |
| 8/16 | −1 | 3 | −7 | 13 | −25 | 81 | 81 | −25 | 13 | −7 | 3 | −1 |
| 9/16 | −1 | 3 | −6 | 12 | −23 | 70 | 91 | −26 | 13 | −7 | 3 | −1 |
| 10/16 | −1 | 3 | −6 | 11 | −21 | 59 | 100 | −26 | 13 | −7 | 4 | −1 |
| 11/16 | −1 | 3 | −6 | 10 | −19 | 49 | 108 | −24 | 12 | −6 | 3 | −1 |
| 12/16 | −1 | 2 | −4 | 8 | −15 | 38 | 115 | −22 | 11 | −6 | 3 | −1 |
| 13/16 | −1 | 2 | −3 | 6 | −11 | 27 | 121 | −18 | 8 | −4 | 2 | −1 |
| 14/16 | 0 | 1 | −2 | 4 | −7 | 17 | 125 | −14 | 7 | −4 | 2 | −1 |
| 15/16 | 0 | 0 | −1 | 2 | −4 | 9 | 127 | −7 | 3 | −2 | 1 | 0 |

The first column in Table 1 represents the pixel position of each sub-pixel. For the 12-tap SHARP filter (sharp filter), each sub-pixel position corresponds to 12 first filter coefficients corresponding to the 12 taps. For SHARP filters with more number of taps, e.g., a 14-tap SHARP filter or 16-tap SHARP filter, the first filter coefficients corresponding to each number of taps at each pixel position may be calculated according to the similar manner as described above. The specific selection is made based on actual situations and is not limited in the embodiments of the present disclosure.

In some embodiments, the regular filter with at least 8 taps includes: a respective second filtering coefficient corresponding to each of the at least 8 taps at each pixel position of at least one pixel position; the second filtering coefficient is obtained by performing processing on a random signal through a second preset sampling function and normalizing a second processing result obtained to the preset coefficient interval. Here, the second preset sampling function may be the same as or different from the first preset sampling function. The calculation manner of the second filtering coefficient is similar to that of the first filtering coefficient, which will not be repeated here.

Exemplarily, the filtering coefficients of the 8-tap regular filter may be as shown in Table 2.

TABLE 2

| | | | | | | | | |
|---|---|---|---|---|---|---|---|---|
| 1/16 | 0 | 2 | −6 | 126 | 8 | −3 | 1 | 0 |
| 2/16 | −1 | 3 | −10 | 123 | 18 | −6 | 2 | −1 |
| 3/16 | −1 | 4 | −14 | 118 | 28 | −9 | 3 | −1 |
| 4/16 | −1 | 5 | −17 | 112 | 38 | −12 | 4 | −1 |
| 5/16 | −1 | 6 | −19 | 105 | 48 | −15 | 5 | −1 |
| 6/16 | −1 | 6 | −20 | 97 | 58 | −17 | 6 | −1 |
| 7/16 | −1 | 6 | −20 | 88 | 69 | −19 | 6 | −1 |
| 8/16 | −1 | 6 | −20 | 79 | 79 | −20 | 6 | −1 |
| 9/16 | −1 | 6 | −19 | 69 | 88 | −20 | 6 | −1 |
| 10/16 | −1 | 6 | −17 | 58 | 97 | −20 | 6 | −1 |
| 11/16 | −1 | 5 | −15 | 48 | 105 | −19 | 6 | −1 |
| 12/16 | −1 | 4 | −12 | 38 | 112 | −17 | 5 | −1 |
| 13/16 | −1 | 3 | −9 | 28 | 118 | −14 | 4 | −1 |
| 14/16 | −1 | 2 | −6 | 18 | 123 | −10 | 3 | −1 |
| 15/16 | 0 | 1 | −3 | 8 | 126 | −6 | 2 | 0 |

S104, pixel value prediction and motion compensation are performed based on the reference block using the first filter, to determine a prediction picture block corresponding to the current block.

In S104, by using the first filter, the decoder performs pixel value prediction based on the reference block, and performs motion compensation on the reference block according to the predicted pixels, to determine the prediction picture block corresponding to the current block.

In the embodiments of the present disclosure, the decoder determines a corresponding number of pixels from the reference block using a corresponding number of taps of the first filter, to perform pixel value prediction; and the decoder performs compensation on the reference block based on the predicted pixels through manners such as weighted averaging, to obtain the prediction picture block corresponding to the current block.

In some embodiments, for the unidirectional prediction (i.e., List0 prediction or List1 prediction) process mentioned above, the decoder performs compensation on the List0 reference block in the List0 reference frame or the List1 reference block in the List1 reference frame according to the pixel values predicted by the first filter (for example, the prediction chroma values and/or luma values), to obtain the prediction picture block corresponding to the current block. For the bidirectional prediction process, the decoder performs compensation on the List0 reference block in the List0 reference frame and the List1 reference block in the List1 reference frame according to the pixel values predicted by the first filter, and then performs weighted prediction on the List0 reference block and the List1 reference block, to obtain the prediction picture block of the current block.

In some embodiments, the decoder may continue to perform filtering processing on a next block in the current frame to determine a prediction picture block corresponding to the next block; continue to perform processing until processing on the current frame is completed; and determine the decoded picture corresponding to the current frame based on prediction picture blocks corresponding to each block in the current frame.

In the embodiments of the present disclosure, taking the first filter being a 12-tap sharp filter as an example, a frequency response comparison between a 12-tap sharp filter and a current 8-tap sharp filter is illustrated in FIG. 5. In FIG. 5, the dashed line represents a frequency response curve of the 8-tap SHARP filter at ½-pixel precision, and the solid line represents a frequency response curve of the 12-tap SHARP filter at ½-pixel precision. It can be seen that, in the embodiments of the present disclosure, the 12-tap SHARP filter effectively reduces the ripple effect in the passband while ensuring the flatness of the passband. In addition, the 12-tap SHARP filter retains the effective signal amplitude characteristics within the cutoff frequency more completely and the noise outside the cutoff frequency is attenuated more rapidly.

It may be understood that the decoder performs pixel value prediction and motion compensation on the reference block corresponding to the current block using the sharp filter with at least 12 taps or the regular filter with at least 8 taps. In this way, compared with the current low-order interpolation filter, filtering precision is improved as well as prediction precision of performing pixel value prediction using the filter is improved, thereby improving accuracy of performing motion compensation and decoding and further improving the performance of decoding.

In some embodiments, the first filter type includes any one of: a sharp filter type, a regular filter type or a smooth filter type; and at least one preset filtering direction includes: a horizontal direction and a vertical direction. For at least one filter type at the decoding end, each filter type corresponds to and includes filters with at least one tap count. In some embodiments, the at least one tap count includes: a first number of taps and a second number of taps, where the second number of taps is smaller than the first number of taps. Here, the filter with the first number of taps is equivalent to a long-tap filter, and the filter with the second number of taps is equivalent to a short-tap filter.

In some embodiments, the filter with the first number of taps may include any one of: a sharp filter with at least 12 taps, a regular filter with at least 8 taps or a 6-tap smooth filter. Exemplarily, there are a 8-tap REGULAR filter and a 4-tap REGULAR filter under the REGULAR filter type; where the 8-tap REGULAR filter is a filter with the first number of taps under the REGULAR filter type, and the 4-tap REGULAR filter is the filter with the second number of taps under the REGULAR filter type. There are a 6-tap SMOOTH filter and a 4-tap SMOOTH filter under the SMOOTH filter type; the 6-tap SMOOTH filter is the filter with the first number of taps under the SMOOTH filter type, and the 4-tap SMOOTH filter is the filter with the second number of taps under the SMOOTH filter type. The filter with the first number of taps under the SHARP filter type may be a 12-tap SHARP filter, and the filter with the second number of taps under the SHARP filter type may use a 4-tap REGULAR filter.

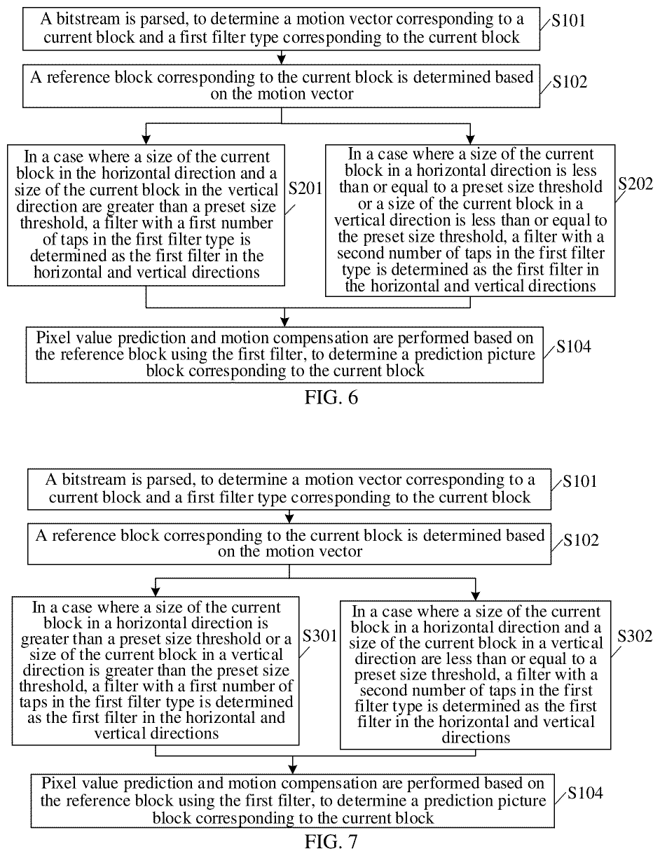

Referring to FIG. 6, S103 in FIG. 4 may be implemented by S201 or S202 as follows.
S201, in a case where a size of the current block in the horizontal direction and a size of the current block in the vertical direction are greater than a preset size threshold, a filter with a first number of taps in the first filter type is determined as the first filter in the horizontal and vertical directions.

In S201 and S202, the filter determines a first filter to be used in the horizontal and vertical directions according to the size of the current block in the horizontal direction and the size of the current block in the vertical direction. In S201, in the case where the size of the current block in the horizontal direction and the size of the current block in the vertical direction are both greater than the preset size threshold, the filter with the first number of taps in the first filter type is determined as the first filter used in the horizontal direction and the first filter used in the vertical direction. In some embodiments, the preset size threshold may be 4, representing 4 pixels.

In some embodiments, the filter with the first number of taps is equivalent to the long-tap filter, and the long-tap filter may be a default filter under the corresponding filter type. Exemplarily, if the first filter type is the SHARP type, in the case where the size of the current block in the horizontal and the size of the current block in the vertical direction are greater than the preset size threshold, the default long-tap filter in the SHARP type (e.g., the sharp filter with at least 12 taps) is determined as the first filter that performs filtering on the current block in the horizontal and vertical directions. If the first filter type is the REGULAR type, in the case where the size of the current block in the horizontal and the size of the current block in the vertical direction are greater than the preset size threshold, the default long-tap filter in the REGULAR type (e.g., the regular filter with at least 8 taps) is determined as the first filter that performs filtering on the current block in the horizontal and vertical directions. If the first filter type is the SMOOTH type, in the case where the size of the current block in the horizontal and the size of the current block in the vertical direction are greater than the preset size threshold, the default long-tap filter in the SMOOTH type (e.g., the 6-tap smooth filter) is determined as the first filter that performs filtering on the current block in the horizontal and vertical directions.
S202, in a case where a size of the current block in a horizontal direction is less than or equal to a preset size threshold or a size of the current block in a vertical direction is less than or equal to the preset size threshold, a filter with a second number of taps in the first filter type is determined as the first filter in the horizontal and vertical directions.

In S202, in the case where the size of the current block in the horizontal direction is less than or equal to the preset size threshold or the size of the current block in the vertical direction is less than or equal to the preset size threshold, that is, in a case where the size of the current block in any one of the horizontal direction or vertical direction is less than or equal to the preset size threshold, the decoder determines the filter with the second number of taps in the first filter type as the first filter in the horizontal direction and the first filter in the vertical direction.

In some embodiments, if the first filter type is the SHARP type, in the case where the size of the current block in the horizontal direction or the vertical direction is less than or equal to the preset size threshold, the short-tap filter in the SHARP type (e.g., the 4-tap sharp filter) is determined as the first filter that performs filtering on the current block in the horizontal and vertical directions. If the first filter type is the REGULAR type, in the case where the size of the current block in the horizontal direction or the vertical direction is less than or equal to the preset size threshold, the short-tap filter in the REGULAR type (e.g., the 4-tap regular filter) is determined as the first filter that performs filtering on the current block in the horizontal and vertical directions. If the first filter type is the SMOOTH type, in the case where the size of the current block in the horizontal direction or the vertical direction is less than or equal to the preset size threshold, the short-tap filter in the SMOOTH type (e.g., the 4-tap smooth filter) is determined as the first filter that performs filtering on the current block in the horizontal and vertical directions.

In some embodiments, referring to FIG. 7, S103 in FIG. 4 may further be implemented by S301 or S302 as follows.
S301, in a case where a size of the current block in a horizontal direction is greater than a preset size threshold or a size of the current block in a vertical direction is greater than the preset size threshold, a filter with a first number of taps in the first filter type is determined as the first filter in the horizontal and vertical directions.

In S301, in the case where the size of the current block in the horizontal direction is greater than the preset size threshold or the size of the current block in the vertical direction is greater than the preset size threshold, that is, in a case where the size of the current block in any one of the horizontal direction or vertical direction is greater than the preset size threshold, the decoder determines the filter with the first number of taps in the first filter type as the first filter in the horizontal direction and the first filter in the vertical direction.

In some embodiments, if the first filter type is the SHARP type, in the case where the size of the current block in the horizontal direction or the vertical direction is greater than the preset size threshold, the default long-tap filter in the SHARP type (e.g., the sharp filter with at least 12 taps) is determined as the first filter that performs filtering on the current block in the horizontal and vertical directions. If the first filter type is the REGULAR type, in the case where the size of the current block in the horizontal direction or the vertical direction is greater than the preset size threshold, the default long-tap filter in the REGULAR type (e.g., the regular filter with at least 8 taps) is determined as the first filter that performs filtering on the current block in the horizontal and vertical directions. If the first filter type is the SMOOTH type, in the case where the size of the current block in the horizontal direction or the vertical direction is greater than or equal to the preset size threshold, the default long-tap filter in the SMOOTH type (e.g., the 6-tap smooth filter) is determined as the first filter that performs filtering on the current block in the horizontal and vertical directions.
S302, in a case where a size of the current block in a horizontal direction and a size of the current block in a vertical direction are less than or equal to a preset size threshold, a filter with a second number of taps in the first filter type is determined as the first filter in the horizontal and vertical directions.

In S302, the size of the current block in the horizontal direction and the size of the current block in the vertical direction are both less than or equal to the preset size threshold, the decoder determines the filter with the second number of taps in the first filter type as the first filter in the horizontal direction and the first filter in the vertical direction.

In some embodiments, if the first filter type is the SHARP type, in the case where the size of the current block in the horizontal direction and the size of the current block in the vertical direction are less than or equal to the preset size threshold, the short-tap filter in the SHARP type (e.g., the 4-tap sharp filter) is determined as the first filter that performs filtering on the current block in the horizontal and vertical directions. If the first filter type is the REGULAR type, in the case where the size of the current block in the horizontal direction and the size of the current block in the vertical direction are less than or equal to the preset size threshold, the short-tap filter in the REGULAR type (e.g., the 4-tap regular filter) is determined as the first filter that performs filtering on the current block in the horizontal and vertical directions. If the first filter type is the SMOOTH type, in the case where the size of the current block in the horizontal direction and the size of the current block in the vertical direction are less than or equal to the preset size threshold, the short-tap filter in the SMOOTH type (e.g., the 4-tap smooth filter) is determined as the first filter that performs filtering on the current block in the horizontal and vertical directions.

It should be noted that S201 or S202 as well as S301 or S302 are two parallel branch processes for implementing S103. In the actual applications, any one of them may be selected for performing according to the situation, and the embodiments of the present disclosure do not impose specific limitations.

It may be understood that the filter with the corresponding number of taps under the first filtering type is determined according to the size of the current block, so as to perform filtering on the current block in the horizontal and vertical directions. In this way, the precision of pixel value prediction may be improved, and the decoding accuracy and decoding performance may be further improved.

In some embodiments, the decoder may further determine the first filter corresponding to the current block by parsing a preset flag in the bitstream. The preset flag may be at sequence-level, frame-level or block-level.

In some embodiments, the encoder may set a sequence-level filtering flag in a video sequence to represent whether a filter with a certain number of taps is enabled. Exemplarily, the sequence-level filtering flag (e.g., a use_longtap flag) may be added to the sequence structure of the video sequence, or an existing sequence-level flag may be taken as the sequence-level filtering flag. The application scope of the sequence-level filtering flag may be a certain specific filter type (e.g., the regular filter) or may be all filter types. Accordingly, the decoder may determine the sequence-level filtering flag by parsing the current video sequence in the bitstream (e.g., parsing a sequence header of the current video sequence). Here, the current video sequence is a video sequence including the current frame, and the current frame includes the current block.

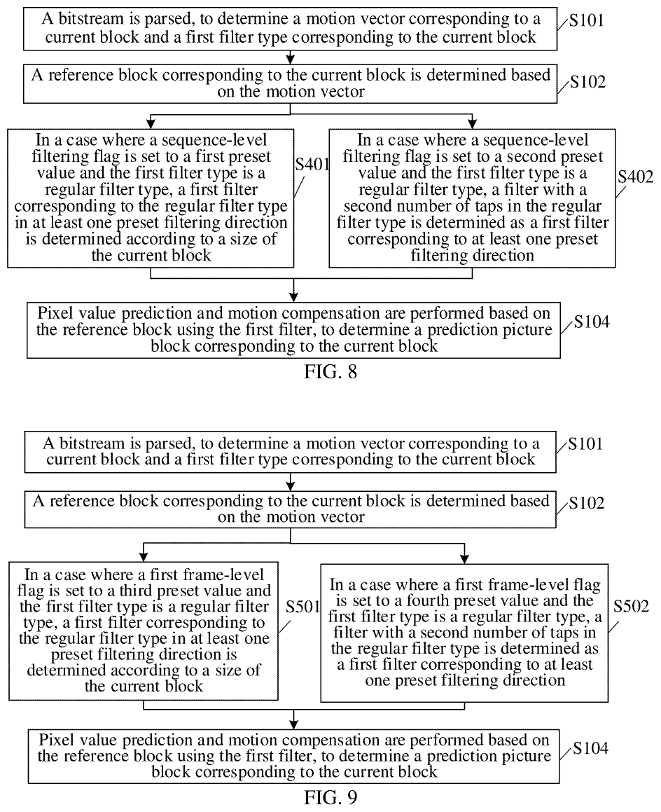

In some embodiments, the sequence-level filtering flag is used to indicate whether the decoder enables the filter with the first number of taps in the regular filter type in the current video sequence. Referring to FIG. 8, S103 in FIG. 4 may also be implemented through S401 or S402 as follows.
S401, in a case where the sequence-level filtering flag is set to a first preset value and the first filter type is a regular filter type, a first filter corresponding to the regular filter type in at least one preset filtering direction is determined according to a size of the current block.

In S401, the first preset value represents that the filter with the first number of taps in the regular filter type (e.g., the 8-tap regular filter) may be used when performing interpolation filtering of motion compensation on blocks within the current video sequence. In some embodiments, the first preset value may be 1.

In some embodiments, in the case where the sequence-level filtering flag is set to the first preset value, it is indicated that the filter with the first number of taps in the regular filter type may be used to perform filtering on the current block. In this way, in a case where the first filter type parsed by the decoder from the current block is the regular filter type, the first filter corresponding to the regular filter type in the at least one preset filtering direction may be determined according to the size of the current block.

Here, the description on the process of determining the first filter corresponding to the regular filter type in the at least one preset filtering direction according to the size of the current block in S401 is consistent with the description on the process in S201 or S202, or the description on the process in S301 or S302, which will not be repeated here. Exemplarily, the process of combining S401 with S201 may include: in the case where the sequence-level filtering flag is set to the first preset value and the first filter type is the regular filter type, responsive to that the size of the current block in the horizontal and the size of the current block in the vertical direction are greater than the preset size threshold, the regular filter with the first number of taps is taken as the first filter. The process of combining S401 with S202, or combining S401 with S301, or combining S401 with S302 is similar and will not be repeated here.
S402, in a case where the sequence-level filtering flag is set to a second preset value and the first filter type is a regular filter type, a filter with a second number of taps in the regular filter type is determined as a first filter corresponding to at least one preset filtering direction.

In S402, the second preset value represents that the filter with the first number of taps in the regular filter type cannot be used when performing interpolation filtering of motion compensation on blocks within the current video sequence. In this way, in the case where the sequence-level filtering flag is set to the second preset value and the first filter type is the regular filter type, for each block in each frame within the current video sequence range, the decoder directly determines the filter with the second number of taps in the regular filter type as the corresponding first filter in the at least one preset filtering direction.

It should be noted that, in the above S401 and S402, the process of adaptively selecting the number of taps of the filter according to the combination of the sequence-level filtering flag with the current block size is described. In some embodiments, the first filter with the corresponding number of taps may also be determined according to the sequence-level filtering flag alone. Exemplarily, in the case where the sequence-level filtering flag is set to the first preset value, for each block in the current video sequence, the filter with the first number of taps under the first filter type may be directly taken as the first filter corresponding to each block in the at least one preset filtering direction. In the case where the sequence-level filtering flag is set to the second preset value, the filter with the second number of taps under the first filter type may be directly taken as the first filter corresponding to each block in the current video sequence in the at least one preset filtering direction.

In some embodiments, the encoder may set a frame-level filtering flag in the current frame to represent whether a filter with a certain number of taps is enabled. Exemplarily, the first frame-level flag may be added to the frame structure, or an existing frame-level flag may be taken as the first frame-level flag. For example, the frame-level screen content coding tool flag allow_screen content tools is taken as the first frame-level flag. At present, when allow_screen_content_tools is 1, it represents that palette encoding is available for the intra block; and when allow_screen_content_tools is 0, it represents that palette encoding is disabled. In the embodiments of the present disclosure, allow_screen_content_tools is taken as the first frame-level flag, when allow_screen_content_tools is 0, it represents that the filter with the first number of taps is enabled within the current frame range, and when allow_screen_content_tools is 1, it represents that the filter with the first number of taps is not used within the current frame range.

In some embodiments, the application scope of the first frame-level flag may be a certain specific filter type (e.g., the regular filter) or may be all filter types. Accordingly, the decoder may determine the first frame-level flag by parsing the current frame in the bitstream (e.g., parsing a frame header of the current frame). Referring to FIG. 9, S103 in FIG. 4 may also be implemented through S501 or S502 as follows.
S501, in a case where the first frame-level flag is set to a third preset value and the first filter type is a regular filter type, a first filter corresponding to the regular filter type in at least one preset filtering direction is determined according to a size of the current block.

In S501, the third preset value represents that the filter with the first number of taps in the regular filter type (e.g., the 8-tap regular filter) may be used when performing interpolation filtering of motion compensation on blocks within the current frame range. In some embodiments, the third preset value may be the same as or different from the first preset value mentioned above. For example, the first frame-level flag may be a screen content coding tool flag, and the third preset value may be 0.

In some embodiments, in the case where the first frame-level flag is set to the third preset value, it is indicated that the filter with the first number of taps in the regular filter type may be used to perform filtering on the current block. In this way, in a case where the first filter type parsed by the decoder from the current block is the regular filter type, the first filter corresponding to the regular filter type in the at least one preset filtering direction may be determined according to the size of the current block.

Here, the description on the process of determining the first filter corresponding to the regular filter type in the at least one preset filtering direction according to the size of the current block in S501 is consistent with the description on the process in S201 or S202, or the description on the process in S301 or S302, which will not be repeated here. Exemplarily, the process of combining S501 with S201 may include: in the case where the first frame-level flag is set to the third preset value and the first filter type is the regular filter type, responsive to that the size of the current block in the horizontal and the size of the current block in the vertical direction are greater than the preset size threshold, the regular filter with the first number of taps is taken as the first filter. The process of combining S401 with S202, or combining S401 with S301, or combining S401 with S302 is similar and will not be repeated here.
S502, in a case where the first frame-level flag is set to a fourth preset value and the first filter type is a regular filter type, a filter with a second number of taps in the regular filter type is determined as a first filter corresponding to at least one preset filtering direction.

In S502, the fourth preset value represents that the filter with the first number of taps in the regular filter type cannot be used when performing interpolation filtering of motion compensation on blocks within the current frame range. In this way, in the case where the first frame-level flag is the second preset value and the first filter type is the regular filter type, for each block in each frame within the current frame range, the decoder directly determines the filter with the second number of taps in the regular filter type as the corresponding first filter in the at least one preset filtering direction. In some embodiments, the fourth preset value may be the same as or different from the second preset value mentioned above. For example, the first frame-level flag may be the screen content coding tool flag, and the fourth preset value may be 1.

It should be noted that, in the above S501 and S502, the process of adaptively selecting the number of taps of the filter according to the combination of the first frame-level flag with the current block size is described. In some embodiments, the first filter with the corresponding number of taps may also be determined according to the first frame-level flag alone. Exemplarily, in the case where the first frame-level flag is set to the third preset value, for each block in the current frame, the filter with the first number of taps under the first filter type may be directly taken as the first filter corresponding to each block in the at least one preset filtering direction. In the case where the first frame-level flag is set to the fourth preset value, the filter with the second number of taps under the first filter type may be directly taken as the first filter corresponding to each block in the current frame in the at least one preset filtering direction.

It should be noted that S401 or S402 as well as S501 or S502 are two parallel branch processes for implementing S103. In the actual applications, any one of them may be selected for performing according to the situation, and the embodiments of the present disclosure do not impose specific limitations.

It may be understood that, in the embodiments of the present disclosure, the filter with the corresponding number of taps under the first filter type is determined by parsing the sequence-level flag or the frame-level flag, and the filter corresponding to the motion compensation process may be determined by combining more indication information, thereby improving the accuracy of filtering prediction and improving decoding performance.

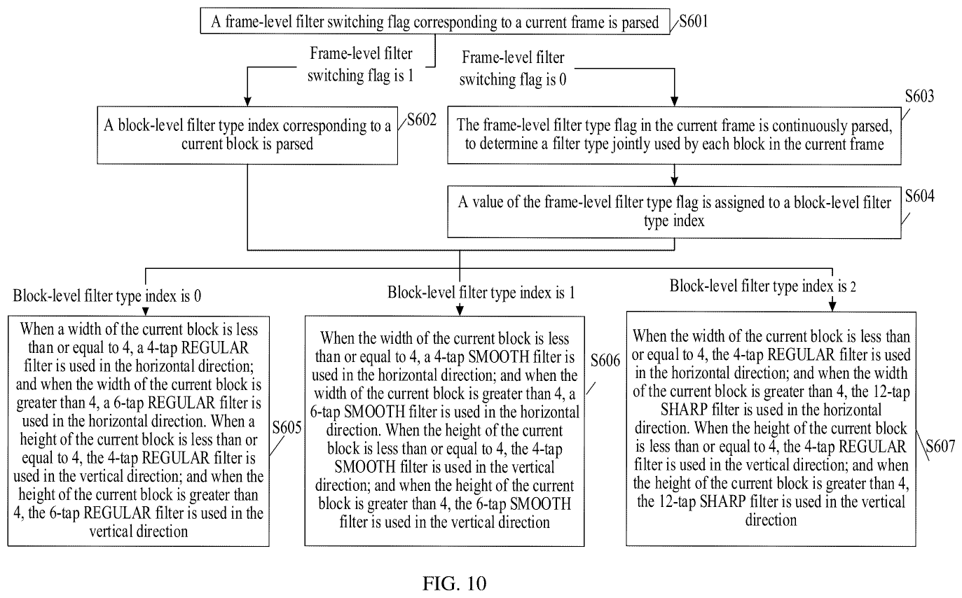

In some embodiments, based on the 12-tap SHARP filter proposed in the embodiments of the present disclosure, the process of the decoder determining the first filter type and the first filter may be illustrated in FIG. 10 as follows.
S601, a frame-level filter switching flag corresponding to a current frame is parsed.

In S601, the frame-level filter switching flag may be is_filter_switchable. When the frame-level filter switching flag is 1, it represents that a block-level filter may be switched when filtering is performed on each block in the current frame, and then S602 is performed. When the frame-level filter switching flag is 0, it represents that the block-level filter cannot be switched, and then S603 is performed.
S602, a block-level filter type index corresponding to a current block is parsed.

In S602, when the block-level filter type index is 0, it represents that the REGULAR type filter is used at block-level, and then S605 is performed. When the block-level filter type index is 1, it represents that the SMOOTH type filter is used at block-level, and then S606 is performed. When the block-level filter type index is 2, it represents that the SHARP type filter is used at block-level, and then S607 is performed.
S603, the frame-level filter type flag in the current frame is continuously parsed, to determine a filter type jointly used by each block in the current frame.
S604, a value of the frame-level filter type flag is assigned to a block-level filter type index.

In S604, when the block-level filter type index is 0, it represents that the REGULAR type filter is used at block-level, and the process proceeds to S605. When the block-level filter type index is 1, it represents that the SMOOTH type filter is used at block-level, and then S606 is performed. When the block-level filter type index is 2, it represents that the SHARP type filter is used at block-level, and then S607 is performed.
S605, in a case where a width of the current block is less than or equal to 4, a 4-tap REGULAR filter is used in the horizontal direction; and in a case where the width of the current block is greater than 4, a 6-tap REGULAR filter is used in the horizontal direction. In a case where a height of the current block is less than or equal to 4, the 4-tap REGULAR filter is used in the vertical direction; and in a case where the height of the current block is greater than 4, the 6-tap REGULAR filter is used in the vertical direction.
S606, in the case where the width of the current block is less than or equal to 4, a 4-tap SMOOTH filter is used in the horizontal direction; and in the case where the width of the current block is greater than 4, a 6-tap SMOOTH filter is used in the horizontal direction. In the case where the height of the current block is less than or equal to 4, the 4-tap SMOOTH filter is used in the vertical direction; and in the case where the height of the current block is greater than 4, the 6-tap SMOOTH filter is used in the vertical direction.
S607, in the case where the width of the current block is less than or equal to 4, the 4-tap REGULAR filter is used in the horizontal direction; and in the case where the width of the current block is greater than 4, the 12-tap SHARP filter is used in the horizontal direction. In the case where the height of the current block is less than or equal to 4, the 4-tap REGULAR filter is used in the vertical direction; and in the case where the height of the current block is greater than 4, the 12-tap SHARP filter is used in the vertical direction.

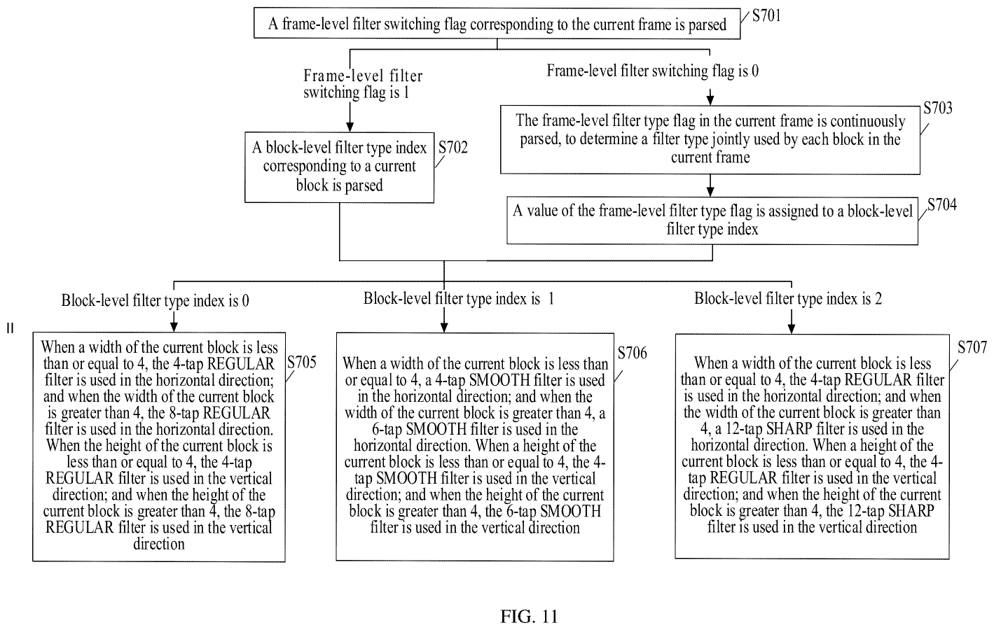

In some embodiments, based on the 12-tap SHARP filter and the 8-tap REGULAR filter proposed in the embodiments of the present disclosure, the process of the decoder determining the first filter type and the first filter may be illustrated in FIG. 11 as follows.
S701, a frame-level filter switching flag corresponding to the current frame is parsed.

In S701, when the frame-level filter switching flag is 1, it represents that the block-level filter may be switched, and then S702 is performed. When the parsed frame-level filter switching flag is 0, it represents that the block-level filter cannot be switched, and then S703 is performed. S702, a block-level filter type index corresponding to a current block is parsed.

In S702, when the block-level filter type index is 0, it represents that the REGULAR type filter is used at block-level, and then S705 is performed. When the block-level filter type index is 1, it represents that the SMOOTH type filter is used at block level, and then S706 is performed. When the block-level filter type index is 2, it represents that the SHARP type filter is used at block-level, and then S707 is performed.
S703, the frame-level filter type flag in the current frame is continuously parsed, to determine a filter type jointly used by each block in the current frame.
S704, a value of the frame-level filter type flag is assigned to a block-level filter type index.

In S704, when the block-level filter type index is 0, it represents that the REGULAR type filter is used at block-level, and then S705 is performed. When the block-level filter type index is 1, it represents that the SMOOTH type filter is used at block-level, and then S706 is performed. When the block-level filter type index is 2, it represents that the SHARP type filter is used at block-level, and then S707 is performed.
S705, in a case where the width of the current block is less than or equal to 4, the 4-tap REGULAR filter is used in the horizontal direction; and in a case where the width of the current block is greater than 4, the 8-tap REGULAR filter is used in the horizontal direction. In a case where the height of the current block is less than or equal to 4, the 4-tap REGULAR filter is used in the vertical direction; and in a case where the height of the current block is greater than 4, the 8-tap REGULAR filter is used in the vertical direction.
S706, in the case where the width of the current block is less than or equal to 4, a 4-tap SMOOTH filter is used in the horizontal direction; and in the case where the width of the current block is greater than 4, a 6-tap SMOOTH filter is used in the horizontal direction. In the case where the height of the current block is less than or equal to 4, the 4-tap SMOOTH filter is used in the vertical direction; and in the case where the height of the current block is greater than 4, the 6-tap SMOOTH filter is used in the vertical direction.
S707, in the case where the width of the current block is less than or equal to 4, the 4-tap REGULAR filter is used in the horizontal direction; and in the case where the width of the current block is greater than 4, a 12-tap SHARP filter is used in the horizontal direction. In the case where the height of the current block is less than or equal to 4, the 4-tap REGULAR filter is used in the vertical direction; and in the case where the height of the current block is greater than 4, the 12-tap SHARP filter is used in the vertical direction.

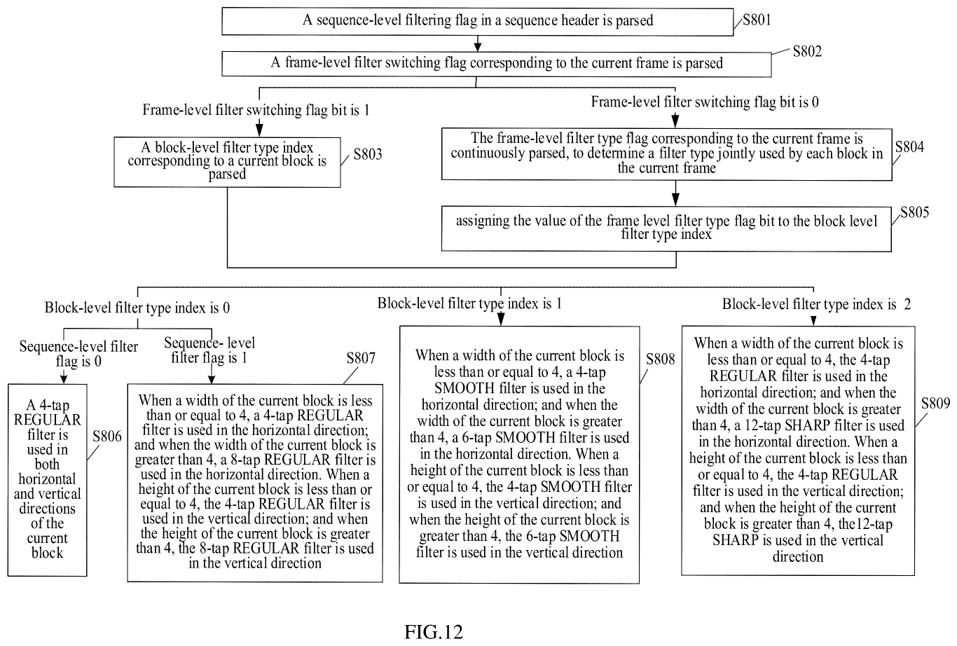

In some embodiments, based on the 12-tap SHARP filter and the 8-tap REGULAR filter proposed in the embodiments of the present disclosure and combined with the sequence-level filtering flag mentioned above, the process of the decoder determining the first filter type and the first filter may be illustrated in FIG. 12 as follows.
S801, a sequence-level filtering flag in a sequence header is parsed.

Where the sequence-level filtering flag may be represented by use_longtap, which has a value of 0 or 1.
S802, a frame-level filter switching flag corresponding to the current frame is parsed.

In S802, when the parsed frame-level filter switching flag is 1, it represents that the block-level filter may be switched, and then S803 is performed. When the parsed frame-level filter switching flag is 0, it represents that the block-level filter cannot be switched, and then S804 is performed.
S803, a block-level filter type index corresponding to a current block is parsed.

In S803, when the block-level filter type index is 0, it represents that the REGULAR type filter is used at block-level, in which when the sequence-level filtering flag (i.e., use_longtap) is 0, S806 is performed; and when use_longtap is 1, S807 is performed. When the block-level filter type index is 1, it represents that the SMOOTH type filter is used at block-level, and then S808 is performed. When the block-level filter type index is 2, it represents that the SHARP type filter is used at block-level, and then S809 is performed.
S804, the frame-level filter type flag corresponding to the current frame is continuously parsed, to determine a filter type jointly used by each block in the current frame.
S805, a value of the frame-level filter type flag is assigned to a block-level filter type index.

In S805, when the block-level filter type index is 0, it represents that the REGULAR type filter is used at block-level, in which when use_longtap is 0, S806 is performed; and when use_longtap is 1, S807 is performed. When the block-level filter type index is 1, it represents that the SMOOTH type filter is used at block-level, and then S808 is performed. When the block-level filter type index is 2, it represents that the SHARP type filter is used at block-level, and then S809 is performed.
S806, a 4-tap REGULAR filter is used in both horizontal and vertical directions of the current block.
S807, in a case where a width of the current block is less than or equal to 4, a 4-tap REGULAR filter is used in the horizontal direction; and in a case where the width of the current block is greater than 4, a 8-tap REGULAR filter is used in the horizontal direction. In a case where a height of the current block is less than or equal to 4, the 4-tap REGULAR filter is used in the vertical direction; and in a case where the height of the current block is greater than 4, the 8-tap REGULAR filter is used in the vertical direction.
S808, in the case where the width of the current block is less than or equal to 4, a 4-tap SMOOTH filter is used in the horizontal direction; and in the case where the width of the current block is greater than 4, a 6-tap SMOOTH filter is used in the horizontal direction. In the case where the height of the current block is less than or equal to 4, the 4-tap SMOOTH filter is used in the vertical direction; and in the case where the height of the current block is greater than 4, the 6-tap SMOOTH filter is used in the vertical direction.
S809, in the case where the width of the current block is less than or equal to 4, the 4-tap REGULAR filter is used in the horizontal direction; and in the case where the width of the current block is greater than 4, a 12-tap SHARP filter is used in the horizontal direction. In a case where the height of the current block is less than or equal to 4, the 4-tap REGULAR filter is used in the vertical direction; and in the case where the height of the current block is greater than 4, the 12-tap SHARP is used in the vertical direction.

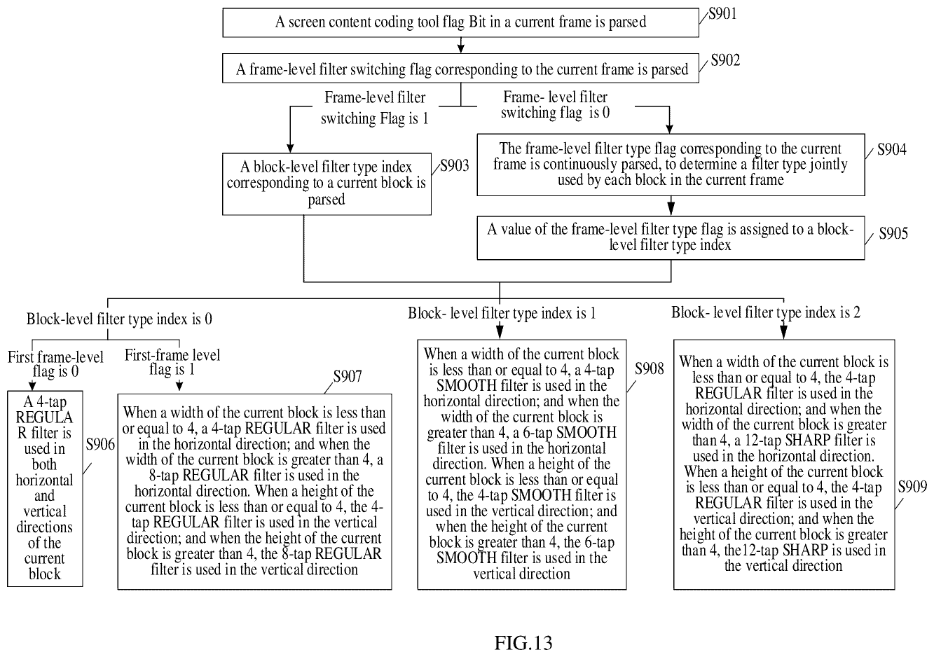

In some embodiments, based on the 12-tap SHARP filter and the 8-tap REGULAR filter proposed in the embodiments of the present disclosure and combined with the first frame-level flag mentioned above (for example, the screen content coding tool flag (allow_screen_content_tools)), the process of the decoder determining the first filter type and the first filter may be illustrated in FIG. 13 as follows.
S901, a screen content coding tool flag allow_screen_content_tools in a current frame is parsed.
S902, a frame-level filter switching flag corresponding to the current frame is parsed.

In S902, when the frame-level filter switching flag is 1, it represents that the block-level filter may be switched, and then S903 is performed. When the parsed frame-level filter switching flag is 0, it represents that the block-level filter cannot be switched, and then S904 is performed.
S903, a block-level filter type index corresponding to a current block is parsed.

In S903, when the block-level filter type index is 0, it represents that the REGULAR type filter is used at block-level, in which when the first frame-level flag (e.g., allow_screen_content_tools) is 1, S906 is performed; and when the first frame-level flag (e.g., allow_screen_content_tools) is 0, S907 is performed. When the block-level filter type index is 1, it represents that the SMOOTH type filter is used at block-level, and then S908 is performed. When the block-level filter type index is 2, it represents that the SHARP type filter is used at block-level, and then S909 is performed.
S904: the frame-level filter type flag corresponding to the current frame is continuously parsed, to determine a filter type jointly used by each block in the current frame.
S905: a value of the frame-level filter type flag is assigned to a block-level filter type index.

In S905, when the block-level filter type index is 0, it represents that the REGULAR type filter is used at block-level, in which when use_longtap is 0, S906 is performed; and when use_longtap is 1, S907 is performed. When the block-level filter type index is 1, it represents that the SMOOTH type filter is used at block-level, and then S908 is performed. When the block level filter type index is 2, it represents that the SHARP type filter is used at block-level, and then S909 is performed.
S906: a 4-tap REGULAR filter is used in both horizontal and vertical directions of the current block.
S907: in a case where a width of the current block is less than or equal to 4, a 4-tap REGULAR filter is used in the horizontal direction; and in a case where the width of the current block is greater than 4, a 8-tap REGULAR filter is used in the horizontal direction. In a case where a height of the current block is less than or equal to 4, the 4-tap REGULAR filter is used in the vertical direction; and in a case where the height of the current block is greater than 4, the 8-tap REGULAR filter is used in the vertical direction.
S908: in the case where the width of the current block is less than or equal to 4, a 4-tap SMOOTH filter is used in the horizontal direction; and in the case where the width of the current block is greater than 4, a 6-tap SMOOTH filter is used in the horizontal direction. In the case where the height of the current block is less than or equal to 4, the 4-tap SMOOTH filter is used in the vertical direction; and in the case where the height of the current block is greater than 4, the 6-tap SMOOTH filter is used in the vertical direction.
S909: in the case where the width of the current block is less than or equal to 4, the 4-tap REGULAR filter is used in the horizontal direction; and in the case where the width of the current block is greater than 4, a 12-tap SHARP filter is used in the horizontal direction. In a case where the height of the current block is less than or equal to 4, the 4-tap REGULAR filter is used in the vertical direction; and in the case where the height of the current block is greater than 4, the 12-tap SHARP is used in the vertical direction.

It may be understood that the interpolation filter selection with improved order and coefficient proposed in the embodiments of the present disclosure is combined with the adaptive filter tap count selection using the sequence-level or frame-level flag, which may improve filtering precision and further enhance encoding performance.

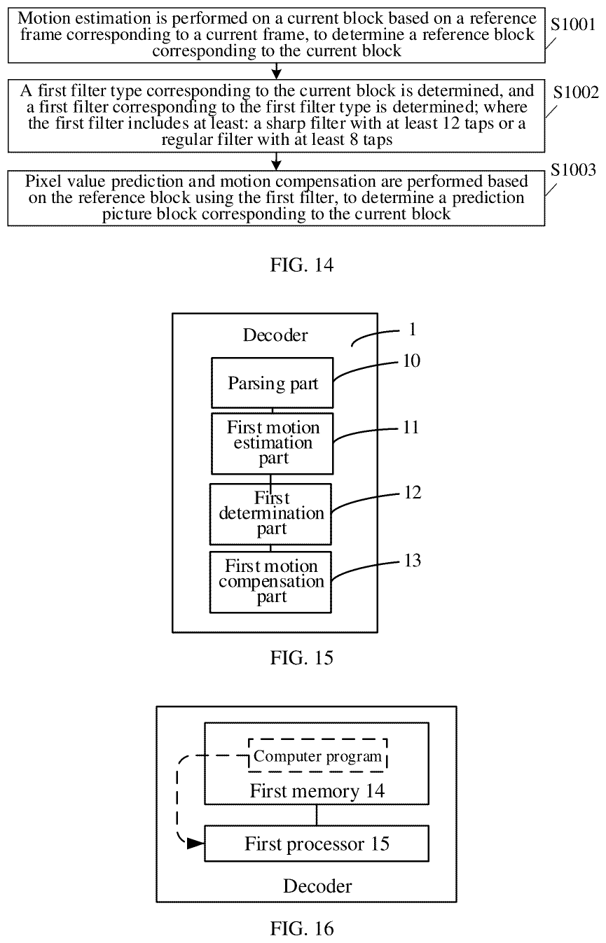

In an embodiment of the present disclosure, referring to FIG. 14, a schematic flowchart of an encoding method according to the embodiments of the present disclosure is illustrated. The method may include the following.
S1001: motion estimation is performed on a current block based on a reference frame corresponding to a current frame, to determine a reference block corresponding to the current block.

In S1001, when performing encoding on the current frame, the encoder performs motion estimation on the current block based on the reference frame corresponding to the current frame, to determine a motion vector corresponding to the current block, and determines the reference block corresponding to the current block in the reference frame according to the motion vector corresponding to the current block. Here, the description on the process of encoder determining the reference block corresponding to the current block in the reference frame according to the motion vector corresponding to the current block is consistent with the description on the relevant process in S102 of the decoder, and will not be repeated here.
S1002: a first filter type corresponding to the current block is determined, and a first filter corresponding to the first filter type is determined; where the first filter includes at least: a sharp filter with at least 12 taps or a regular filter with at least 8 taps.

In S1002, the encoder may determine the first filter type corresponding to the current block according to the encoding cost. In some embodiments, the encoding cost may be a rate-distortion cost. The encoder may perform interpolation filtering on the current block according to at least one filter type, to determine at least one rate-distortion cost of the current block under the at least one filter type, and determine the first filter type corresponding to the current block according to the at least one rate-distortion cost. Exemplarily, a filter type having the lowest rate-distortion cost is taken as the first filter type.

It should be noted that the meaning the first filter in the encoder is the same as that of the first filter in the decoder. Similarly, the sharp filter with at least 12 taps includes: a respective first filtering coefficient corresponding to each of the at least 12 taps at each pixel position of at least one pixel position, where the first filtering coefficient is obtained by performing processing on a random signal through a first preset sampling function and normalizing a first processing result obtained to a preset coefficient interval corresponding to a preset bit depth. The regular filter with at least 8 taps includes: a respective second filtering coefficient corresponding to each of the at least 8 taps at each pixel position of at least one pixel position, where the second filtering coefficient is obtained by performing processing on a random signal through a second preset sampling function and normalizing a second processing result obtained to the preset coefficient interval. Here, the pixel position includes a pixel position of an integer pixel and a pixel position of a non-integer pixel.

Exemplarily, the filter coefficients of the 12-tap sharp filter are shown in Table 1, and the filter coefficients of the 8-tap regular filter are shown in Table 2.

In some embodiments, the operation that the first filter corresponding to the first filter type is determined in S1002 includes: determining a first filter corresponding to the first filter type in at least one preset filtering direction according to a size of the current block.

In some embodiments, the first filter type includes any one of: a sharp filter type, a regular filter type or a smooth filter type; and the at least one preset filtering direction includes: a horizontal direction and a vertical direction. The above operation of determining the first filter corresponding to the first filter type in the at least one preset filtering direction according to the size of the current block includes the following. In a case where a size of the current block in the horizontal direction and a size of the current block in the vertical direction are greater than a preset size threshold, a filter with a first number of taps in the first filter type is determined as the first filter in the horizontal and vertical directions, where the filter with the first number of taps includes any one of: the sharp filter with at least 12 taps, the regular filter with at least 8 taps or a 6-tap smooth filter.

In some embodiments, the above operation of determining the first filter corresponding to the first filter type in the at least one preset filtering direction according to the size of the current block includes the following. In a case where a size of the current block in a horizontal direction is less than or equal to a preset size threshold or a size of the current block in a vertical direction is less than or equal to the preset size threshold, a filter with a second number of taps in the first filter type is determined as the first filter in the horizontal and vertical directions, where the second number of taps is less than the first number of taps.

In some embodiments, the above operation of determining the first filter corresponding to the first filter type in the at least one preset filtering direction according to the size of the current block includes the following. In a case where a size of the current block in a horizontal direction is greater than a preset size threshold or a size of the current block in a vertical direction is greater than the preset size threshold, a filter with a first number of taps in the first filter type is determined as the first filter in the horizontal and vertical directions.

In some embodiments, the above operation of determining the first filter corresponding to the first filter type in the at least one preset filtering direction according to the size of the current block includes the following. In a case where a size of the current block in a horizontal direction and a size of the current block in a vertical direction are less than or equal to a preset size threshold, a filter with a second number of taps in the first filter type is determined as the first filter in the horizontal and vertical directions.

Here, the description on above method for the encoder to determine the first filter corresponding to the first filter type is consistent with the description on process of the same method in the decoder, and will not be repeated here.
S1003: pixel value prediction and motion compensation are performed based on the reference block using the first filter, to determine a prediction picture block corresponding to the current block.

In S1003, by using the first filter, the encoder performs pixel interpolation filtering on the reference block to obtain predicted pixels corresponding to the reference block, and performs motion compensation on the reference block according to the predicted pixels to obtain a prediction picture block corresponding to the current block. Here, the description on the process of the motion compensation process is consistent with the description on the process in S104 at the decoder side, and will not be repeated here.

It may be understood that the encoder performs pixel value prediction and motion compensation on the reference block corresponding to the current block using the sharp filter with at least 12 taps or the regular filter with at least 8 taps. In this way, compared with the current low-order interpolation filter, filtering precision is improved as well as prediction precision of performing pixel value prediction using the filter is improved, thereby improving accuracy of performing motion compensation and encoding and further improving the performance of encoding.

In some embodiments, after determining the prediction picture block corresponding to the current block in S1003, the encoder may continue to perform filtering processing on a next block in the current frame until processing on the current frame is completed, and determine encoding information corresponding to the current frame according to prediction picture blocks corresponding to each block in the current frame; and continue to encode a next frame in a current video sequence, to determine encoding information corresponding to the next frame until processing on the current video sequence is completed, and determine encoding information corresponding to each frame in the current video sequence.

In some embodiments, the encoder may determine a sequence-level filtering flag corresponding to the current video sequence, where the sequence-level filtering flag is used to indicate whether a decoder enables a filter with a first number of taps in a regular filter type in the current video sequence; and determine bitstream information corresponding to the current video sequence according to the sequence-level filtering flag and the encoding information corresponding to each frame. Here, the encoder encodes the sequence-level filtering flag and the encoding information corresponding to each frame in the current video sequence into a bitstream and transmits the bitstream to the decoder, to enable the decoder to parse the sequence-level filtering flag corresponding to the current video sequence in the bitstream through the process of S401 or S402, and to determine the first filter used by the decoder for the current block.

In some embodiments, after determining the prediction picture block corresponding to the current block in S1003, the encoder may further continue to perform filtering processing on a next block in the current frame until processing on the current frame is completed, and determine encoding information corresponding to the current frame according to prediction picture blocks corresponding to each block in the current frame. The encoder determines a first frame-level flag corresponding to the current frame, where the first frame-level flag is used to indicate whether a decoder enables a filter with a first number of taps in a regular filter type in the current frame; and determines bitstream information corresponding to the current frame according to the first frame-level flag and the encoding information corresponding to the current frame. Here, the encoder encodes the first frame-level flag and the encoding information corresponding to the current frame into a bitstream and transmits the bitstream to the decoder, to enable the decoder to parse the first frame-level flag corresponding to the current frame in the bitstream through the process of S501 or S502, and to determine the first filter used by the decoder for the current block.

Based on the implementation basis of the above embodiments, as illustrated in FIG. 15, the embodiments of the present disclosure provides a decoder 1, and the decoder 1 includes:
a parsing part 10, configured to parse a bitstream, to determine a motion vector corresponding to a current block and a first filter type corresponding to the current block;
a first motion estimation part 11, configured to determine a reference block corresponding to the current block based on the motion vector;
a first determination part 12, configured to determine a first filter corresponding to the first filter type, where the first filter includes at least: a sharp filter with at least 12 taps or a regular filter with at least 8 taps; and
a first motion compensation part 13, configured to perform pixel value prediction and motion compensation based on the reference block using the first filter, to determine a prediction picture block corresponding to the current block.

In some embodiments of the present disclosure, the first determination part 12 is further configured to determine a first filter corresponding to the first filter type in at least one preset filtering direction according to a size of the current block.

In some embodiments of the present disclosure, the first filter type includes any one of: a sharp filter type, a regular filter type or a smooth filter type; and the at least one preset filtering direction includes: a horizontal direction and a vertical direction. The first determination part 12 is further configured to determine a filter with a first number of taps in the first filter type as the first filter in the horizontal and vertical directions in a case where a size of the current block in the horizontal direction and a size of the current block in the vertical direction are greater than a preset size threshold. The filter with the first number of taps includes any one of: the sharp filter with at least 12 taps, the regular filter with at least 8 taps or a 6-tap smooth filter.

In some embodiments of the present disclosure, the first determination part 12 is further configured to determine, in a case where a size of the current block in a horizontal direction is less than or equal to a preset size threshold or a size of the current block in a vertical direction is less than or equal to the preset size threshold, a filter with a second number of taps in the first filter type as the first filter in the horizontal and vertical directions; and the second number of taps is less than a first number of taps.

In some embodiments of the present disclosure, the first determination part 12 is further configured to determine, in a case where a size of the current block in a horizontal direction is greater than a preset size threshold or a size of the current block in a vertical direction is greater than the preset size threshold, a filter with a first number of taps in the first filter type as the first filter in the horizontal and vertical directions.

In some embodiments of the present disclosure, the first determination part 12 is further configured to determine, in a case where a size of the current block in a horizontal direction and a size of the current block in a vertical direction are less than or equal to a preset size threshold, a filter with a second number of taps in the first filter type as the first filter in the horizontal and vertical directions.

In some embodiments of the present disclosure, before performing pixel value prediction and motion compensation based on the reference block using the first filter, to determine the prediction picture block corresponding to the current block, the parsing part 10 is further configured to parse a current video sequence in the bitstream, to determine a sequence-level filtering flag. The first determination part 12 is further configured to determine, in a case where the sequence-level filtering flag is set to a first preset value and the first filter type is a regular filter type, a first filter corresponding to the regular filter type in at least one preset filtering direction according to a size of the current block; and determine, in a case where the sequence-level filtering flag is set to a second preset value and the first filter type is a regular filter type, a filter with a second number of taps in the regular filter type as a first filter corresponding to at least one preset filtering direction.

In some embodiments of the present disclosure, before performing pixel value prediction and motion compensation based on the reference block using the first filter, to determine the prediction picture block corresponding to the current block, the parsing part 10 is further configured to parse a current frame in the bitstream, to determine a first frame-level flag. The first determination part 12 is further configured to determine, in a case where the first frame-level flag is set to a third preset value and the first filter type is a regular filter type, a first filter corresponding to the regular filter type in at least one preset filtering direction according to a size of the current block; and determine, in a case where the first frame-level flag is set to a fourth preset value and the first filter type is a regular filter type, a filter with a second number of taps in the regular filter type as a first filter corresponding to at least one preset filtering direction.

In some embodiments of the present disclosure, the sharp filter with at least 12 taps includes: a respective first filtering coefficient corresponding to each of the at least 12 taps at each pixel position of at least one pixel position, where the first filtering coefficient is obtained by performing processing on a random signal through a first preset sampling function and normalizing a first processing result obtained to a preset coefficient interval corresponding to a preset bit depth; and the regular filter with at least 8 taps includes: a respective second filtering coefficient corresponding to each of the at least 8 taps at each pixel position of at least one pixel position, where the second filtering coefficient is obtained by performing processing on a random signal through a second preset sampling function and normalizing a second processing result obtained to the preset coefficient interval.

In the practical applications of the present disclosure, as illustrated in FIG. 16, the embodiments of the present disclosure further provides a decoder, and the decoder includes:
a first memory 14 and a first processor 15;
where the first memory 14 is configured to store a computer program executable on the first processor 15; and the first processor 15 is configured to implement the video decoding method provided by the embodiments of the present disclosure when executing the computer program.

The first processor 15 may be implemented by software, hardware, firmware, or a combination thereof, and may use circuitry, single or multiple application specific integrated circuits (ASICs), single or multiple general purpose integrated circuits, single or multiple microprocessors, single or multiple programmable logic devices, or combinations of the aforementioned circuitry or devices, or other suitable circuitry or devices, so that the first processor 15 may perform corresponding steps of the video decoding method provided by the embodiments of the present disclosure.

It is to be noted that the description of the above decoder embodiments is similar to that of the above method embodiments, and has similar beneficial effects as the method embodiments. For technical details not disclosed in the decoder embodiments of the present disclosure, refer to the description of the method embodiments of the present disclosure for understanding.

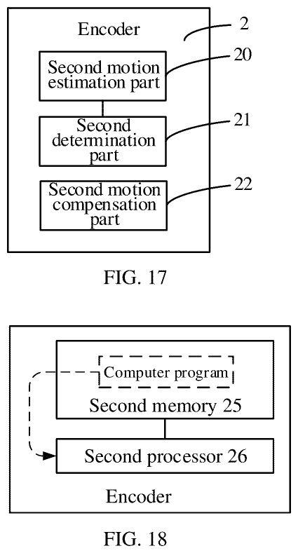

The embodiments of the present disclosure provides an encoder 2, as illustrated in FIG. 17, and the encoder 2 includes:
a second motion estimation part 20, configured to perform motion estimation on a current block based on a reference frame corresponding to a current frame, to determine a reference block corresponding to the current block;
a second determination part 21, configured to determine a first filter type corresponding to the current block, and determine a first filter corresponding to the first filter type, where the first filter includes at least: a sharp filter with at least 12 taps or a regular filter with at least 8 taps; and
a second motion compensation part 22, configured to perform pixel value prediction and motion compensation based on the reference block using the first filter, to determine a prediction picture block corresponding to the current block.

In some embodiments of the present disclosure, the second determination part 21 is further configured to determine the first filter type corresponding to the current block according to at least one distortion cost corresponding to at least one filter type.

In some embodiments of the present disclosure, the second determination part 21 is further configured to determine a first filter corresponding to the first filter type in at least one preset filtering direction according to a size of the current block.

In some embodiments of the present disclosure, the first filter type includes any one of: a sharp filter type, a regular filter type or a smooth filter type; and the at least one preset filtering direction includes: a horizontal direction and a vertical direction. The second determination part 21 is further configured to determine a filter with a first number of taps in the first filter type as the first filter in the horizontal and vertical directions in a case where a size of the current block in the horizontal direction and a size of the current block in the vertical direction are greater than a preset size threshold. The filter with the first number of taps includes any one of: the sharp filter with at least 12 taps, the regular filter with at least 8 taps or a 6-tap smooth filter.

In some embodiments of the present disclosure, the second determination part 21 is further configured to determine, in a case where a size of the current block in a horizontal direction is less than or equal to a preset size threshold or a size of the current block in a vertical direction is less than or equal to the preset size threshold, a filter with a second number of taps in the first filter type as the first filter in the horizontal and vertical directions, where the second number of taps is less than a first number of taps.

In some embodiments of the present disclosure, the second determination part 21 is further configured to determine, in a case where a size of the current block in a horizontal direction is greater than a preset size threshold or a size of the current block in a vertical direction is greater than the preset size threshold, a filter with a first number of taps in the first filter type as the first filter in the horizontal and vertical directions.

In some embodiments of the present disclosure, the second determination part 21 is further configured to determine, in a case where a size of the current block in a horizontal direction and a size of the current block in a vertical direction are less than or equal to a preset size threshold, a filter with a second number of taps in the first filter type as the first filter in the horizontal and vertical directions.

In some embodiments of the present disclosure, after determining the prediction picture block corresponding to the current block, the encoder 2 further includes an encoding part. The encoding part is configured to continue to perform filtering processing on a next block in the current frame until processing on the current frame is completed, and determine encoding information corresponding to the current frame according to prediction picture blocks corresponding to each block in the current frame; and continue to encode a next frame in a current video sequence, to determine encoding information corresponding to the next frame until processing on the current video sequence is completed, and determine encoding information corresponding to each frame in the current video sequence. The second determination part 21 is further configured to determine a sequence-level filtering flag corresponding to the current video sequence, where the sequence-level filtering flag is used to indicate whether a decoder enables a filter with a first number of taps in a regular filter type in the current video sequence. The encoding part is further configured to determine bitstream information corresponding to the current video sequence according to the sequence-level filtering flag and the encoding information corresponding to each frame.

In some embodiments of the present disclosure, after determining the prediction picture block corresponding to the current block, the encoding part is configured to continue to perform filtering processing on a next block in the current frame until processing on the current frame is completed, and determine encoding information corresponding to the current frame according to prediction picture blocks corresponding to each block in the current frame. The second determination part 21 is further configured to determine a first frame-level flag corresponding to the current frame, where the first frame-level flag is used to indicate whether a decoder enables a filter with a first number of taps in a regular filter type in the current frame. The encoding part is further configured to determine bitstream information corresponding to the current frame according to the first frame-level flag and the encoding information corresponding to the current frame.

In some embodiments of the present disclosure, the sharp filter with at least 12 taps includes: a respective first filtering coefficient corresponding to each of the at least 12 taps at each pixel position of at least one pixel position, where the first filtering coefficient is obtained by performing processing on a random signal through a first preset sampling function and normalizing a first processing result obtained to a preset coefficient interval corresponding to a preset bit depth; and the regular filter with at least 8 taps includes: a respective second filtering coefficient corresponding to each of the at least 8 taps at each pixel position of at least one pixel position, where the second filtering coefficient is obtained by performing processing on a random signal through a second preset sampling function and normalizing a second processing result obtained to the preset coefficient interval.

In the practical applications, as illustrated in FIG. 18, the embodiments of the present disclosure further provides an encoder, and the encoder includes:
a second memory 25 and a second processor 26;
where the second memory 25 is configured to store a computer program executable on the second processor 26, and the second processor 26 is configured to implement the video encoding method provided by the embodiments of the present disclosure when executing the computer program.

It is to be noted that the description of the above encoder embodiments is similar to that of the above method embodiments, and has similar beneficial effects as the method embodiments. For technical details not disclosed in the encoder embodiments of the present disclosure, refer to the description of the method embodiments of the present disclosure for understanding.

The embodiments of the present disclosure provide a bitstream, and the bitstream is generated by bit encoding based on information to be coded. The information to be encoded is determined based on a prediction picture block corresponding to a current block, the prediction picture block corresponding to the current block is obtained by performing pixel value prediction and motion compensation based on a reference block corresponding to the current block through a first filter corresponding to the current block, and the first filter includes at least: a sharp filter with at least 12 taps or a regular filter with at least 8 taps.

The embodiments of the present disclosure provide a non-transitory computer-readable storage medium having a computer program stored thereon. When the computer program is executed by the first processor, the video decoding method provided by the embodiments of the present disclosure is implemented; or when the computer program is executed by the second processor, the video encoding method provided by the embodiments of the present disclosure is implemented.

The various components in the embodiments of the present application may be integrated into one processing unit, or each unit may be physically present, or two or more units may be integrated into one unit. The above-mentioned integrated unit can be implemented in the form of hardware or a software functional module.

The integrated unit may be stored in a computer readable storage when it is implemented in the form of a software functional module and is sold or used as a separate product. Based on such understanding, the technical solutions of the embodiments essentially, or the part of the technical solutions that contributes to the related art, or all or part of the technical solutions, may be embodied in the form of a computer software product which is stored in a non-transitory storage medium and includes instructions for causing a computer device (which may be a personal computer, a server, or a network device and so on) or a processor to perform all or part of the steps described in the various embodiments of the present application. The above non-transitory storage medium includes various media that can store program codes, such as ferromagnetic random access memory (FRAM), read-only memory (ROM), programmable read-only memory (PROM), erasable programmable read-only memory (EPROM), electrically erasable programmable read-only memory (EEPROM), flash memory, magnetic surface memory, an optical disc, or compact disc read-only memory (CD-ROM, which is not limited in the implementations of the present application.

In a first clause, provided is a video decoding method, and the method includes:
parsing a bitstream, to determine a motion vector corresponding to a current block and a first filter type corresponding to the current block;
determining a reference block corresponding to the current block based on the motion vector;
determining a first filter corresponding to the first filter type, where the first filter includes at least: a sharp filter with at least 12 taps or a regular filter with at least 8 taps; and
performing pixel value prediction and motion compensation based on the reference block using the first filter, to determine a prediction picture block corresponding to the current block.

In a second clause, the method of the first clause, where determining the first filter corresponding to the first filter type includes:
determining a first filter corresponding to the first filter type in at least one preset filtering direction according to a size of the current block.

In a third clause, the method of the second clause, the first filter type includes any one of: a sharp filter type, a regular filter type or a smooth filter type; and the at least one preset filtering direction includes: a horizontal direction and a vertical direction;
where determining the first filter corresponding to the first filter type in the at least one preset filtering direction according to the size of the current block includes:
in a case where a size of the current block in the horizontal direction and a size of the current block in the vertical direction are greater than a preset size threshold, determining a filter with a first number of taps in the first filter type as the first filter in the horizontal and vertical directions, where the filter with the first number of taps includes any one of: the sharp filter with at least 12 taps, the regular filter with at least 8 taps or a 6-tap smooth filter.

In a fourth clause, the method of the second clause, where determining the first filter corresponding to the first filter type in the at least one preset filtering direction according to the size of the current block includes:
in a case where a size of the current block in a horizontal direction is less than or equal to a preset size threshold or a size of the current block in a vertical direction is less than or equal to the preset size threshold, determining a filter with a second number of taps in the first filter type as the first filter in the horizontal and vertical directions, where the second number of taps is less than a first number of taps.

In a fifth clause, the method of the second clause, where determining the first filter corresponding to the first filter type in the at least one preset filtering direction according to the size of the current block includes:
in a case where a size of the current block in a horizontal direction is greater than a preset size threshold or a size of the current block in a vertical direction is greater than the preset size threshold, determining a filter with a first number of taps in the first filter type as the first filter in the horizontal and vertical directions.

In a sixth clause, the method of the second clause, where determining the first filter corresponding to the first filter type in the at least one preset filtering direction according to the size of the current block includes:
in a case where a size of the current block in a horizontal direction and a size of the current block in a vertical direction are less than or equal to a preset size threshold, determining a filter with a second number of taps in the first filter type as the first filter in the horizontal and vertical directions.

In a seventh clause, the method of any one of the first to sixth clauses, where before performing pixel value prediction and motion compensation based on the reference block using the first filter, to determine the prediction picture block corresponding to the current block, the method further includes:
parsing a current video sequence in the bitstream, to determine a sequence-level filtering flag;
where determining the first filter corresponding to the first filter type includes:
in a case where the sequence-level filtering flag is set to a first preset value and the first filter type is a regular filter type, determining a first filter corresponding to the regular filter type in at least one preset filtering direction according to a size of the current block; or
in a case where the sequence-level filtering flag is set to a second preset value and the first filter type is a regular filter type, determining a filter with a second number of taps in the regular filter type as a first filter corresponding to at least one preset filtering direction.

In an eighth clause, the method of any one of the first to sixth clauses, where before performing pixel value prediction and motion compensation based on the reference block using the first filter, to determine the prediction picture block corresponding to the current block, the method further includes:
parsing a current frame in the bitstream, to determine a first frame-level flag;
where determining the first filter corresponding to the first filter type includes:
in a case where the first frame-level flag is set to a third preset value and the first filter type is a regular filter type, determining a first filter corresponding to the regular filter type in at least one preset filtering direction according to a size of the current block; or
in a case where the first frame-level flag is set to a fourth preset value and the first filter type is a regular filter type, determining a filter with a second number of taps in the regular filter type as a first filter corresponding to at least one preset filtering direction.

In a ninth clause, the method of any one of the first to sixth clauses, the sharp filter with at least 12 taps includes: a respective first filtering coefficient corresponding to each of the at least 12 taps at each pixel position of at least one pixel position, where the first filtering coefficient is obtained by performing processing on a random signal through a first preset sampling function and normalizing a first processing result obtained to a preset coefficient interval corresponding to a preset bit depth; and
the regular filter with at least 8 taps includes: a respective second filtering coefficient corresponding to each of the at least 8 taps at each pixel position of at least one pixel position, where the second filtering coefficient is obtained by performing processing on a random signal through a second preset sampling function and normalizing a second processing result obtained to the preset coefficient interval.

In a tenth clause, provided is a video encoding method, and the method includes:
performing motion estimation on a current block based on a reference frame corresponding to a current frame, to determine a reference block corresponding to the current block;
determining a first filter type corresponding to the current block, and determining a first filter corresponding to the first filter type, where the first filter includes at least: a sharp filter with at least 12 taps or a regular filter with at least 8 taps; and
performing pixel value prediction and motion compensation based on the reference block using the first filter, to determine a prediction picture block corresponding to the current block.

In an eleventh clause, the method of the tenth clause, where determining the first filter type corresponding to the current block includes:
determining the first filter type corresponding to the current block according to at least one distortion cost corresponding to at least one filter type.

In a twelfth clause, the method of the tenth or eleventh clause, where determining the first filter corresponding to the first filter type includes:
determining a first filter corresponding to the first filter type in at least one preset filtering direction according to a size of the current block.

In a thirteenth clause, the method of the twelfth clause, where the first filter type includes any one of: a sharp filter type, a regular filter type or a smooth filter type; and the at least one preset filtering direction includes: a horizontal direction and a vertical direction;
where determining the first filter corresponding to the first filter type in the at least one preset filtering direction according to the size of the current block includes:
in a case where a size of the current block in the horizontal direction and a size of the current block in the vertical direction are greater than a preset size threshold, determining a filter with a first number of taps in the first filter type as the first filter in the horizontal and vertical directions, where the filter with the first number of taps includes any one of: the sharp filter with at least 12 taps, the regular filter with at least 8 taps or a 6-tap smooth filter.

In a fourteenth clause, the method of the twelfth clause, where determining the first filter corresponding to the first filter type in the at least one preset filtering direction according to the size of the current block includes:
in a case where a size of the current block in a horizontal direction is less than or equal to a preset size threshold or a size of the current block in a vertical direction is less than or equal to the preset size threshold, determining a filter with a second number of taps in the first filter type as the first filter in the horizontal and vertical directions, where the second number of taps is less than a

In a fifteenth clause, the method of the twelfth clause, where determining the first filter corresponding to the first filter type in the at least one preset filtering direction according to the size of the current block includes:
in a case where a size of the current block in a horizontal direction is greater than a preset size threshold or a size of the current block in a vertical direction is greater than the preset size threshold, determining a filter with a first number of taps in the first filter type as the first filter in the horizontal and vertical directions.

In a sixteenth clause, the method of the twelfth clause, where determining the first filter corresponding to the first filter type in the at least one preset filtering direction according to the size of the current block includes:
in a case where a size of the current block in a horizontal direction and a size of the current block in a vertical direction are less than or equal to a preset size threshold, determining a filter with a second number of taps in the first filter type as the first filter in the horizontal and vertical directions.

In a seventeenth clause, the method of any one of the tenth, eleventh and thirteenth to sixteenth clauses, where after determining the prediction picture block corresponding to the current block, the method further includes:
continuing to perform filtering processing on a next block in the current frame until processing on the current frame is completed, and determining encoding information corresponding to the current frame according to prediction picture blocks corresponding to each block in the current frame;
continuing to encode a next frame in a current video sequence, to determine encoding information corresponding to the next frame until processing on the current video sequence is completed, and determining encoding information corresponding to each frame in the current video sequence;
determining a sequence-level filtering flag corresponding to the current video sequence, where the sequence-level filtering flag is used to indicate whether a decoder enables a filter with a first number of taps in a regular filter type in the current video sequence; and
determining bitstream information corresponding to the current video sequence according to the sequence-level filtering flag and the encoding information corresponding to each frame.

In an eighteenth clause, the method of any one of the tenth, eleventh and thirteenth to sixteenth clauses, where after determining the prediction picture block corresponding to the current block, the method further includes:
continuing to perform filtering processing on a next block in the current frame until processing on the current frame is completed, and determining encoding information corresponding to the current frame according to prediction picture blocks corresponding to each block in the current frame;
determining a first frame-level flag corresponding to the current frame, where the first frame-level flag is used to indicate whether a decoder enables a filter with a first number of taps in a regular filter type in the current frame; and
determining bitstream information corresponding to the current frame according to the first frame-level flag and the encoding information corresponding to the current frame.

In a nineteenth clause, the method of any one of the tenth, eleventh and thirteenth to sixteenth clauses, the sharp filter with at least 12 taps includes: a respective first filtering coefficient corresponding to each of the at least 12 taps at each pixel position of at least one pixel position, where the first filtering coefficient is obtained by performing processing on a random signal through a first preset sampling function and normalizing a first processing result obtained to a preset coefficient interval corresponding to a preset bit depth; and
the regular filter with at least 8 taps includes: a respective second filtering coefficient corresponding to each of the at least 8 taps at each pixel position of at least one pixel position, where the second filtering coefficient is obtained by performing processing on a random signal through a second preset sampling function and normalizing a second processing result obtained to the preset coefficient interval.

In a twentieth clause, provided is a decoder, and the decoder includes:
a parsing part, configured to parse a bitstream, to determine a motion vector corresponding to a current block and a first filter type corresponding to the current block;
a first motion estimation part, configured to determine a reference block corresponding to the current block based on the motion vector;
a first determination part, configured to determine a first filter corresponding to the first filter type, where the first filter includes at least: a sharp filter with at least 12 taps or a regular filter with at least 8 taps; and
a first motion compensation part, configured to perform pixel value prediction and motion compensation based on the reference block using the first filter, to determine a prediction picture block corresponding to the current block.

In a twenty-first clause, provided is an encoder, and the encoder includes:
a second motion estimation part, configured to perform motion estimation on a current block based on a reference frame corresponding to a current frame, to determine a reference block corresponding to the current block;
a second determination part, configured to determine a first filter type corresponding to the current block, and determine a first filter corresponding to the first filter type, where the first filter includes at least: a sharp filter with at least 12 taps or a regular filter with at least 8 taps; and
a second motion compensation part, configured to perform pixel value prediction and motion compensation based on the reference block using the first filter, to determine a prediction picture block corresponding to the current block.

In a twenty-second clause, provided is decoder, and the decoder includes:
a first memory, configured to store executable instructions; and
a first processor, configured to implement the method according to any one of the first to ninth clauses when executing the executable instructions stored in the first memory.

In a twenty-third clause, provided is an encoder, and the encoder includes:
a second memory, configured to store executable instructions; and
a second processor, configured to implement the method according to any one of the tenth to nineteenth clauses when executing the executable instructions stored in the second memory.

In a twenty-fourth clause, provided is a bitstream, where the bitstream is generated by bit encoding according to information to be encoded, where the information to be encoded is determined based on a prediction picture block corresponding to a current block, the prediction picture block corresponding to the current block is obtained by performing pixel value prediction and motion compensation based on a reference block corresponding to the current block through a first filter corresponding to the current block, and the first filter includes at least: a sharp filter with at least 12 taps or a regular filter with at least 8 taps.

In a twenty-fifth clause, provided is a computer-readable storage medium, storing executable instructions, where the executable instructions, when executed by a first processor, implement the method according to any one of the first to ninth clauses, or the executable instructions, when executed by a second processor, implement the method according to any one of the tenth to nineteenth clauses.

The foregoing are merely specific implementations of the present disclosure, but the protection scope of the present disclosure is not limited thereto. Any person skilled in the art may readily conceive variations or substitutions within the technical scope disclosed by the present disclosure, which should be included within the protection scope of the present disclosure. Therefore, the protection scope of the present disclosure shall be subject to the protection scope of the claims.

### INDUSTRIAL APPLICABILITY

The embodiments of the present disclosure provide a video encoding and decoding method, a decoder, an encoder and a computer-readable storage medium. The decoder and encoder may perform pixel value prediction and motion compensation on the reference block corresponding to the current block using the sharp filter with at least 12 taps or the regular filter with at least 8 taps. In this way, compared with the current low-order interpolation filter, filtering precision is improved as well as prediction precision of performing pixel value prediction using the filter is improved, thereby improving the accuracy of motion compensation and the accuracy of encoding and decoding and further improving the performance of encoding and decoding. In addition, the filter with the corresponding number of taps under the first filtering type is determined according to the size of the current block, so as to perform filtering on the current block in the horizontal and vertical directions. In this way, the precision of pixel value prediction may be improved, thereby further improving the accuracy of encoding and decoding and the performance of encoding and decoding. Furthermore, the filter with the corresponding number of taps under the first filter type is determined by parsing the sequence-level flag or the frame-level flag, the filter corresponding to the motion compensation process may be determined by combining more indication information, thereby improving the accuracy of filtering prediction and improving the performance of encoding and decoding.

What is claimed is:

1. A video decoding method, comprising:
parsing a bitstream, to determine a motion vector corresponding to a current block and a first filter type corresponding to the current block;
determining a reference block corresponding to the current block based on the motion vector;
determining a first filter corresponding to the first filter type, wherein the first filter comprises at least: a sharp filter with at least 12 taps or a regular filter with at least 8 taps; and
performing pixel value prediction and motion compensation based on the reference block using the first filter, to determine a prediction picture block corresponding to the current block.

2. The method according to claim 1, wherein determining the first filter corresponding to the first filter type comprises:
determining a first filter corresponding to the first filter type in at least one preset filtering direction according to a size of the current block.

3. The method according to claim 2, wherein the first filter type comprises any one of: a sharp filter type, a regular filter type or a smooth filter type; and the at least one preset filtering direction comprises: a horizontal direction and a vertical direction;
wherein determining the first filter corresponding to the first filter type in the at least one preset filtering direction according to the size of the current block comprises:
in a case where a size of the current block in the horizontal direction and a size of the current block in the vertical direction are greater than a preset size threshold, determining a filter with a first number of taps in the first filter type as the first filter in the horizontal and vertical directions, wherein the filter with the first number of taps comprises any one of: the sharp filter with at least 12 taps, the regular filter with at least 8 taps or a 6-tap smooth filter.

4. The method according to claim 2, wherein determining the first filter corresponding to the first filter type in the at least one preset filtering direction according to the size of the current block comprises:
in a case where a size of the current block in a horizontal direction is less than or equal to a preset size threshold or a size of the current block in a vertical direction is less than or equal to the preset size threshold, determining a filter with a second number of taps in the first filter type as the first filter in the horizontal and vertical directions, wherein the second number of taps is less than a

5. The method according to claim 2, wherein determining the first filter corresponding to the first filter type in the at least one preset filtering direction according to the size of the current block comprises:
in a case where a size of the current block in a horizontal direction is greater than a preset size threshold or a size of the current block in a vertical direction is greater than the preset size threshold, determining a filter with a first number of taps in the first filter type as the first filter in the horizontal and vertical directions.

6. The method according to claim 2, wherein determining the first filter corresponding to the first filter type in the at least one preset filtering direction according to the size of the current block comprises:
in a case where a size of the current block in a horizontal direction and a size of the current block in a vertical direction are less than or equal to a preset size threshold, determining a filter with a second number of taps in the first filter type as the first filter in the horizontal and vertical directions.

7. The method according to claim 1, wherein before performing pixel value prediction and motion compensation based on the reference block using the first filter, to determine the prediction picture block corresponding to the current block, the method further comprises:
parsing a current video sequence in the bitstream, to determine a sequence-level filtering flag;
wherein determining the first filter corresponding to the first filter type comprises:
in a case where the sequence-level filtering flag is set to a first preset value and the first filter type is a regular filter type, determining a first filter corresponding to the regular filter type in at least one preset filtering direction according to a size of the current block; or
in a case where the sequence-level filtering flag is set to a second preset value and the first filter type is a regular filter type, determining a filter with a second number of taps in the regular filter type as a first filter corresponding to at least one preset filtering direction.

8. The method according to claim 1, wherein before performing pixel value prediction and motion compensation based on the reference block using the first filter, to determine the prediction picture block corresponding to the current block, the method further comprises:
parsing a current frame in the bitstream, to determine a first frame-level flag;
wherein determining the first filter corresponding to the first filter type comprises:
in a case where the first frame-level flag is set to a third preset value and the first filter type is a regular filter type, determining a first filter corresponding to the regular filter type in at least one preset filtering direction according to a size of the current block; or
in a case where the first frame-level flag is set to a fourth preset value and the first filter type is a regular filter type, determining a filter with a second number of taps in the regular filter type as a first filter corresponding to at least one preset filtering direction.

9. The method according to claim 1, wherein
the sharp filter with at least 12 taps comprises: a respective first filtering coefficient corresponding to each of the at least 12 taps at each pixel position of at least one pixel position, wherein the first filtering coefficient is obtained by performing processing on a random signal through a first preset sampling function and normalizing a first processing result obtained to a preset coefficient interval corresponding to a preset bit depth; and
the regular filter with at least 8 taps comprises: a respective second filtering coefficient corresponding to each of the at least 8 taps at each pixel position of at least one pixel position, wherein the second filtering coefficient is obtained by performing processing on a random signal through a second preset sampling function and normalizing a second processing result obtained to the preset coefficient interval.

10. A video encoding method, comprising:
performing motion estimation on a current block based on a reference frame corresponding to a current frame, to determine a reference block corresponding to the current block;
determining a first filter type corresponding to the current block, and determining a first filter corresponding to the first filter type, wherein the first filter comprises at least: a sharp filter with at least 12 taps or a regular filter with at least 8 taps; and
performing pixel value prediction and motion compensation based on the reference block using the first filter, to determine a prediction picture block corresponding to the current block.

11. The method according to claim 10, wherein determining the first filter type corresponding to the current block comprises:
determining the first filter type corresponding to the current block according to at least one distortion cost corresponding to at least one filter type.

12. The method according to claim 10, wherein determining the first filter corresponding to the first filter type comprises:
determining a first filter corresponding to the first filter type in at least one preset filtering direction according to a size of the current block.

13. The method according to claim 12, wherein the first filter type comprises any one of: a sharp filter type, a regular filter type or a smooth filter type; and the at least one preset filtering direction comprises: a horizontal direction and a vertical direction;
wherein determining the first filter corresponding to the first filter type in the at least one preset filtering direction according to the size of the current block comprises:
in a case where a size of the current block in the horizontal direction and a size of the current block in the vertical direction are greater than a preset size threshold, determining a filter with a first number of taps in the first filter type as the first filter in the horizontal and vertical directions, wherein the filter with the first number of taps comprises any one of: the sharp filter with at least 12 taps, the regular filter with at least 8 taps or a 6-tap smooth filter.

14. The method according to claim 12, wherein determining the first filter corresponding to the first filter type in the at least one preset filtering direction according to the size of the current block comprises:
in a case where a size of the current block in a horizontal direction is less than or equal to a preset size threshold or a size of the current block in a vertical direction is less than or equal to the preset size threshold, determining a filter with a second number of taps in the first filter type as the first filter in the horizontal and vertical directions, wherein the second number of taps is less than a first number of taps.

15. The method according to claim 12, wherein determining the first filter corresponding to the first filter type in the at least one preset filtering direction according to the size of the current block comprises:
in a case where a size of the current block in a horizontal direction is greater than a preset size threshold or a size of the current block in a vertical direction is greater than the preset size threshold, determining a filter with a first number of taps in the first filter type as the first filter in the horizontal and vertical directions.

16. The method according to claim 12, wherein determining the first filter corresponding to the first filter type in the at least one preset filtering direction according to the size of the current block comprises:
in a case where a size of the current block in a horizontal direction and a size of the current block in a vertical direction are less than or equal to a preset size threshold, determining a filter with a second number of taps in the first filter type as the first filter in the horizontal and vertical directions.

17. The method according to claim 10, wherein after determining the prediction picture block corresponding to the current block, the method further comprises:
continuing to perform filtering processing on a next block in the current frame until processing on the current frame is completed, and determining encoding information corresponding to the current frame according to prediction picture blocks corresponding to each block in the current frame;
continuing to encode a next frame in a current video sequence, to determine encoding information corresponding to the next frame until processing on the current video sequence is completed, and determining encoding information corresponding to each frame in the current video sequence;
determining a sequence-level filtering flag corresponding to the current video sequence, wherein the sequence-level filtering flag is used to indicate whether a decoder enables a filter with a first number of taps in a regular filter type in the current video sequence; and
determining bitstream information corresponding to the current video sequence according to the sequence-level filtering flag and the encoding information corresponding to each frame.

18. The method according to claim 10, wherein after determining the prediction picture block corresponding to the current block, the method further comprises:
continuing to perform filtering processing on a next block in the current frame until processing on the current frame is completed, and determining encoding information corresponding to the current frame according to prediction picture blocks corresponding to each block in the current frame;
determining a first frame-level flag corresponding to the current frame, wherein the first frame-level flag is used to indicate whether a decoder enables a filter with a first number of taps in a regular filter type in the current frame; and
determining bitstream information corresponding to the current frame according to the first frame-level flag and the encoding information corresponding to the current frame.

19. The method according to claim 10, wherein
the sharp filter with at least 12 taps comprises: a respective first filtering coefficient corresponding to each of the at least 12 taps at each pixel position of at least one pixel position, wherein the first filtering coefficient is obtained by performing processing on a random signal through a first preset sampling function and normalizing a first processing result obtained to a preset coefficient interval corresponding to a preset bit depth; and
the regular filter with at least 8 taps comprises: a respective second filtering coefficient corresponding to each of the at least 8 taps at each pixel position of at least one pixel position, wherein the second filtering coefficient is obtained by performing processing on a random signal through a second preset sampling function and normalizing a second processing result obtained to the preset coefficient interval.

20. A computer-readable storage medium storing a bitstream, wherein bitstream is generated by bit encoding according to information to be encoded, wherein the information to be encoded is determined based on a prediction picture block corresponding to a current block, the prediction picture block corresponding to the current block is obtained by performing pixel value prediction and motion compensation based on a reference block corresponding to the current block through a first filter corresponding to the current block, and the first filter comprises at least: a sharp filter with at least 12 taps or a regular filter with at least 8 taps.
